(19) United States
(12) Patent Application Publication
(10) Pub. No.: US 2024/0115930 A1
(43) Pub. Date: Apr. 11, 2024

(54) GAMING SYSTEM FOR AUTOMATED BLACKJACK DETECTION AND ELECTRONIC NOTIFICATION

(71) Applicant: LNW Gaming, Inc., Las Vegas, NV (US)

(72) Inventors: Matthew J. LUCCHETTI, Las Vegas, NV (US); Michael VIZZO, Las Vegas, NV (US); Paul SCHEPER, Bloomington, MN (US)

(21) Appl. No.: 18/481,713

(22) Filed: Oct. 5, 2023

Related U.S. Application Data
(60) Provisional application No. 63/413,381, filed on Oct. 5, 2022.

(51) Int. Cl. A63F 1/14; A63F 1/16

(52) U.S. Cl. CPC A63F 1/14; A63F 1/16; A63F 2001/003

(57) ABSTRACT

A system includes one or more elements (e.g., a processor) configured to determine, via a smart card-handling device in response to an initial deal for a playing round of a blackjack game, that an upward-facing card of a dealer's initial hand indicates a first required rank value of a natural hand. The system further automatically detects, based on electronic analysis of card-draw timestamp data, card-draw image data, and game settings, whether a rank value of a downward-facing card of the dealer's initial hand indicates a second required rank value of the natural hand. The automatic detection occurs without exposing the downward-facing card and prior to another card being drawn, for the playing round, after the initial deal. Furthermore, the system indicates, via one or more electronic indicators, whether the dealer's initial hand either equates to the natural hand or does not equate to the natural hand.

### RELATED APPLICATIONS

This patent application claims priority benefit to U.S. Provisional Patent Application No. 63/413,381 filed Oct. 5, 2022. The 63/413,381 Application is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### TECHNICAL FIELD

This disclosure relates generally to networked gaming systems and, more specifically, to automated tracking of card-handling data within a gaming environment and determining one or more game states based on analysis of the card-handling data.

### BACKGROUND

Gaming devices used in the gaming industry, such as electronic gaming machines (EGMs), card-handling devices, and the like, are used for increasing the efficiency, security, and game speed in games such as blackjack, baccarat, poker, and reel-based games. The gaming devices are deployed in a gaming environment (e.g., a casino). At least some gaming devices generate and/or collect data associated with gameplay, device diagnostics, and/or the like. The gaming devices may be communicatively coupled to a network to store and analyze the data from the gaming devices using a centralized data processing system. Casinos make money from a house edge on every bet. The higher the turnover of bets, the more profit from the edge. Achieving a balance between entertainment value for players and profitability can be a daunting task. One aspect that affects profitability is the rate of play. When the rate of play increases, more games can be played at a gaming device. For example, if a dealer can increase the rate of play at a gaming table, then more games can be played at the table, hence more bets placed, leading to higher revenue for the casino operator.

Currently, to speed up the rate of play, some casinos implement a rule called a “no peek” rule, whereby dealers can check a downward-facing card (i.e., a hole card or “down card”) of a blackjack hand if the upward-facing card (i.e., a revealed card or “up card”) shows a possible natural 21 (e.g., if the up card is a 10-value card, like a “10” or a face card, or if the up card is an 11-value card, like an Ace). Using the no-peek rule, dealers can utilize a device that will permit the dealer to check, immediately after the initial deal (and before any additional play continues for the round), whether the dealer has a natural hand (i.e., a natural 21). The “no-peek” device can, for example, include a housing into which the dealer inserts their hand (including the down card). The device further includes a card reader, such as a mirror or prism, which reflects a corner of the dealer's down card so that the dealer can see the rank value of the down card. However, such a conventional technique requires a specific physical device (i.e., the “no-peek” device itself), which device includes the casing and the mirror. Furthermore, the no-peek device also requires the use of specialized playing cards (e.g., a specialized card having an offset of the corner indicia so that the corner indicia can be viewed within the reflection of the no-peek device). Consequently, the conventional no-peek device assists to increase the rate of play (i.e., to stop play of the current playing round, after the initial deal has been made, if the dealer has a natural 21—to move more quickly to the next playing round). However, the conventional no-peek device still requires effort by the dealer to insert the card hand into the casing of the no-peek device and to look at the reflection of the down card in the mirror. Furthermore, use of the no-peek device requires that the dealer be able to see, and accurately read, the reflection of the corner of the down card. Given that environmental lighting in a casino is not always consistent, and given the small size of the reflective mirror, a chance exists for the dealer to mistakenly read the down card.

Hence, it is desirable for gaming manufacturers to develop innovative ways of automatically detecting a dealer blackjack hand without requiring the dealer to use the conventional no-peek device.

### SUMMARY

A system includes one or more elements (e.g., a processor) configured to determine, via a smart card-handling device in response to dealer input received after an initial deal for a playing round of a blackjack game, that an upward-facing card of a dealer's initial hand indicates a first required rank value of a natural hand. The system further automatically detects, based on an electronic analysis of card-draw timestamp data, an electronic analysis of card-draw image data, and an electronic analysis of game settings, whether a rank value of a downward-facing card of the dealer's initial hand indicates a second required rank value of the natural hand. The automatic detection occurs without exposing the downward-facing card and prior to another card being drawn, for the playing round, after the initial deal. Furthermore, in response to the automatically detecting whether the rank value of the downward-facing card indicates the second required rank value, the system is further configured to indicate, via one or more electronic indicators, whether the dealer's initial hand either equates to the natural hand or does not equate to the natural hand.

### BRIEF DESCRIPTION OF THE DRAWINGS

FIG. 1 is a block diagram in accordance with at least one embodiment of the present disclosure;

FIGS. 2A and 2B are diagrams of smart card-handling devices in accordance with one or more embodiments of the present disclosure;

FIG. 3 is a schematic diagram showing a card-recognition system in accordance with at least one embodiment of the present disclosure;

FIG. 4 is a flow diagram of an example method of automatically determining dealer blackjack from an initial deal based, at least in part, on card-handling data analysis in accordance with at least one embodiment of the present disclosure;

FIG. 5. is a diagram illustrating determining dealer blackjack from an initial deal based, at least in part, on card-handling analysis and game setting analysis in accordance with at least one embodiment of the present disclosure;

FIG. 6 is a perspective view of a gaming table configured for implementation of embodiments of wagering games in accordance with the present disclosure.

FIG. 7 is a top view of a table configured for implementation of embodiments of wagering games in accordance with the present disclosure;

FIG. 8 is a perspective view of another embodiment of a table configured for implementation of embodiments of wagering games in accordance with the present disclosure, wherein the implementation includes a virtual dealer;

FIG. 9 is a schematic block diagram of a gaming system for implementing embodiments of wagering games in accordance with the present disclosure;

FIG. 10 is a schematic block diagram of a gaming system for implementing embodiments of wagering games including a live dealer feed according to the present disclosure; and

FIG. 11 is a block diagram of a computer for acting as a gaming system for implementing embodiments of wagering games in accordance with the present disclosure.

The figures depict various embodiments for purposes of illustration only. One skilled in the art who also has the benefit of this disclosure may recognize from the following discussion that alternative embodiments of the structures and methods illustrated herein may be employed without departing from the principles described herein.

### DETAILED DESCRIPTION

The present disclosure illustrates, in various embodiments, systems and methods of locating and communicating with networked, moveable gaming devices.

In the following description, circuits and functions may be shown in block diagram form in order not to obscure the descriptions in unnecessary detail. Conversely, specific circuit implementations shown and described are examples only and should not be construed as the only way to implement networked gaming devices unless specified otherwise herein. Additionally, block definitions and partitioning of logic between various blocks illustrates one possible embodiment. It may become apparent to one of skill in the art, who also has the benefit of this disclosure, that the embodiments disclosed may be practiced by various other partitioning solutions, all of which are contemplated herein.

Further, the term “module” is used herein in a non-limiting sense to indicate functionality of particular circuits and/or assemblies within embodiments of networked gaming device systems and is not to be construed as requiring a particular physical structure, or particular partitioning between elements for performing the indicated functions.

When executed as firmware or software, the instructions for performing the methods and processes described herein may be stored on a computer readable medium. A computer readable medium includes, but is not limited to, magnetic and optical storage devices such as disk drives, magnetic tape, CDs (compact discs), DVDs (digital versatile discs or digital video discs), and semiconductor devices such as RAM, DRAM, ROM, EPROM, and Flash memory.

The processors described herein process data signals and may comprise various computing architectures such as a complex instruction set computer (CISC) architecture, a reduced instruction set computer (RISC) architecture, or an architecture implementing a combination of instruction sets. Although only a single processor may be shown, multiple processors may be included. The processors comprise an arithmetic logic unit, a microprocessor, a general-purpose computer, or some other information appliance equipped to transmit, receive, and process electronic data signals from an associated memory and/or one or more input/output devices

The memory described herein stores instructions and/or data that may be executed and/or accessed by the associated processor. The instructions and/or data may comprise code for performing any and/or all of the techniques described herein. The memory may be a dynamic random-access memory (DRAM) device, a static random-access memory (SRAM) device, Flash RAM (non-volatile storage), combinations of the above, or some other memory device known in the art. While the memory may be shown within some devices, some of the memory can be remote, e.g., on a separate device connected to the device or via a WAN, e.g., a cloud-based storage device.

As used herein, a “gaming device” or “game device” refers to an apparatus associated with one or more aspects of a gaming environment. For example, a gaming device may include card-handling devices (e.g., shufflers and shoes), electronic gaming machines (EGMs), and/or other devices the provide gameplay features for a game. Gaming devices may also include devices that are not directly involved in gameplay, such as information kiosks, displays, currency conversion devices, and the like. The foregoing examples of gaming devices are for exemplary purposes only and do not limit the gaming devices to the examples mentioned above.

As used herein, a “gaming environment” or “casino environment” is a location or multiple locations in which one or more games (particularly, wagering games) are conducted. Although some gaming environments may not include any gaming devices, in the embodiments described herein, at least one gaming device is deployed at the gaming environment to facilitate play of the one or more games.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

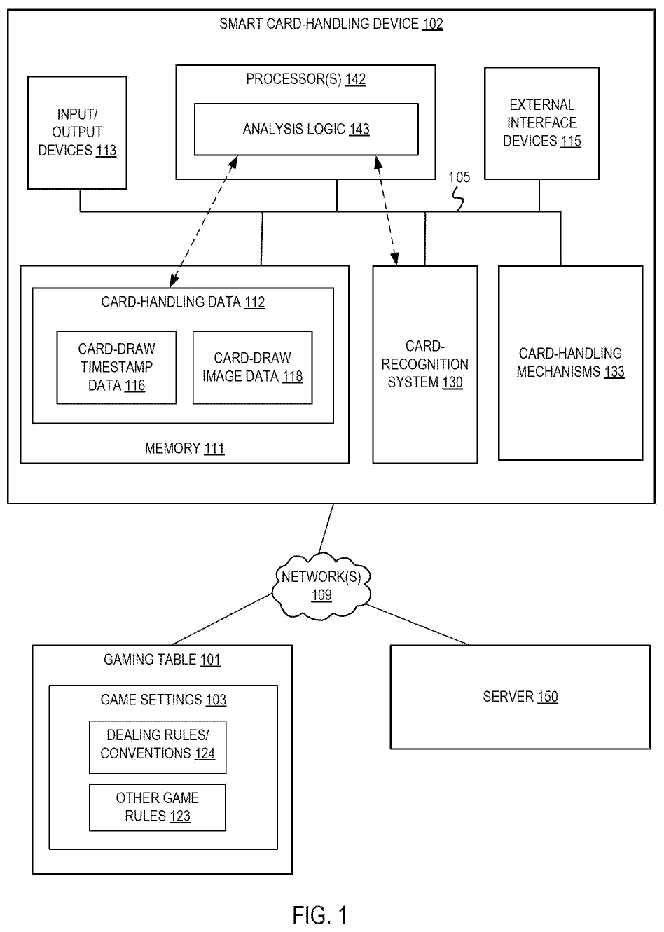

FIG. 1 is a diagram according to one embodiment of the present disclosure. In the example embodiment, a gaming device (e.g., a smart card-handling device 102, such as a smart shoe or smart shuffler) may be associated with a particular stationary gaming table (table 101). For example, the smart card-handling device 102 may be deployed to the table 101 for play of a card-based game, such as blackjack. The smart card-handling device 102 includes one or more processors 142, input/output devices 113 (e.g., a dealer input device, natural-hand indicator(s), a display, etc.), card-handling mechanisms 133 (e.g., a shoe or dispenser mechanism, a card-return mechanism, a card-movement mechanism, a shuffling mechanism, etc.), a card recognition system 130, external interface devices 115, and a memory 111 configured, in one embodiment, to store data related to card-handling, such as, card-draw timestamp data 116 and card-draw image data 118. The various elements of the smart card-handling device 102 can be communicatively coupled via a bus 105. The smart card-handling device 102 and table 101 may, in some embodiments, be configured to generate and communicate the data with a server 150 (e.g., via one of the external interface devices 115). The smart card-handling device 102, the table 101 and/or the server 150 may be communicatively coupled via one or more gaming networks (e.g., network(s) 109).

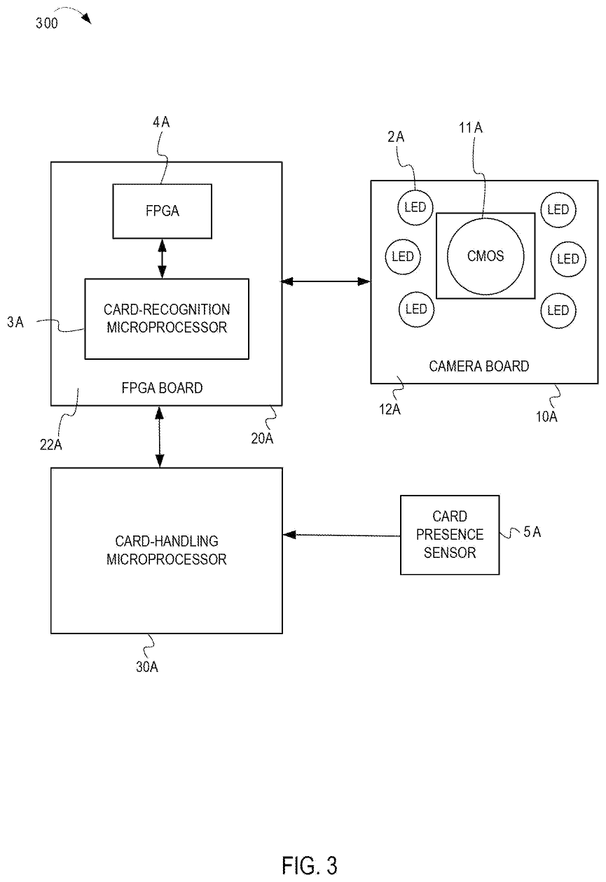

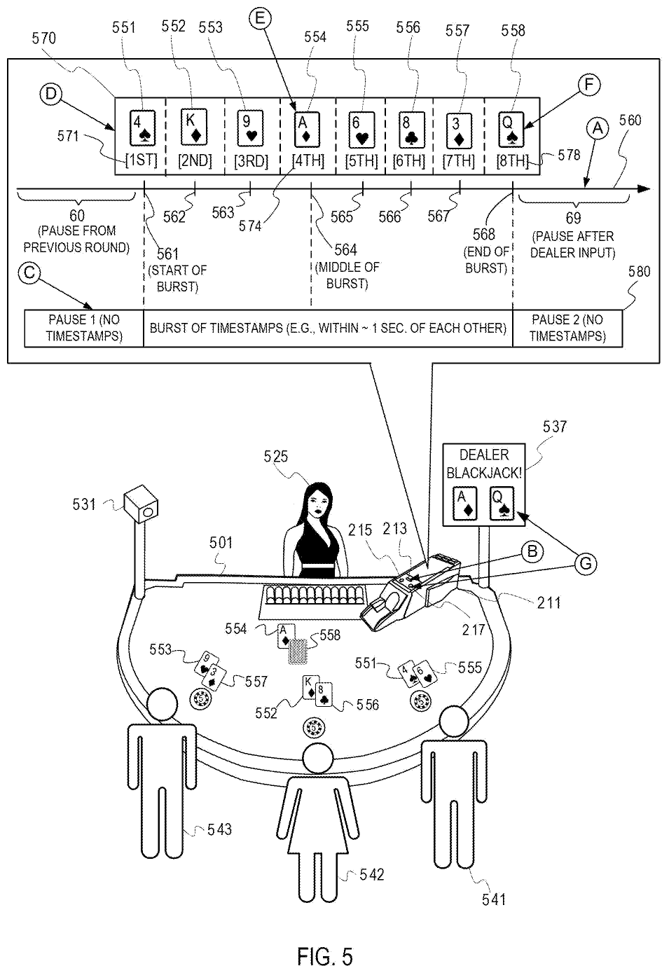

When a game of blackjack is played at the table 101, a dealer draws cards from a shoe of the smart card-handling device 102 and deals the cards to each of several players (e.g., players 541, 542, and 543 in FIG. 5) during an initial deal of a playing round. As each card is dealt, the smart card-handling device 102 stores and analyzes (and/or transmit for analysis) timing data (e.g., a timestamp) corresponding to the dealing of the card. The smart card-handling device 102 stores the timing data as the card-draw timestamp data 116. The card-handling mechanisms 133 cause the smart card-handling device 102 to receive collected game cards (e.g., via a card-return mechanism), and move the cards (e.g., via a card-moving mechanism) to the shoe for drawing during the blackjack game, such as during the initial deal. The card-recognition system 130 is configured to collect (e.g., capture) the card-draw image data 118 for cards that are drawn from the smart card-handling device 102 (e.g., via a camera and/or other card-recognition device(s) associated with the shoe, e.g., see FIG. 3). The card-recognition system 130 captures and stores images of the cards in the card-draw image data 118. In some embodiments, the card-recognition system 130 is configured to analyze (e.g., via use of the analysis logic 143 or other internal logic—e.g., see FIG. 3) the card-draw image data 118 to electronically detect face values (e.g., symbols or other indicia on the face of the drawn cards) to ascertain at least the rank value of the drawn cards. The smart card-handling device 102 keeps track of the detected face values as well as an order in which the cards are dealt, and stores the face value data and card order data (along with any other card-handling information) in the card-handling data 112.

In one example the card-recognition system 130 includes the card-recognition system 300 shown in FIG. 3. In another example, the card-recognition system 130 includes the card reading system described in U.S. Pat. No. 9,387,390, issued Jul. 12, 2016 to Downs, III et al., which U.S. Pat. No. 9,387,390 Patent is hereby incorporated by reference in its entirety. In another example, the card-recognition system 130 includes the card reading system described in U.S. Pat. No. 7,933,444, issued Apr. 26, 2011 to Downs, III et al., which U.S. Pat. No. 7,933,444 Patent is hereby incorporated by reference in its entirety. In another example, the card-recognition system 130 includes the card reading system described in U.S. Pat. No. 8,538,155 to Downs, III et al., which U.S. Pat. No. 8,538,155 Patent is hereby incorporated by reference in its entirety.

The one or more processors (processor(s) 142) perform operations via analysis logic 143. The analysis logic 143, for instance, analyzes card-handling data 112 (e.g., card-draw timestamp data 116 and card-draw image data 118) as well as game settings 122 (e.g., game rules 123 and dealing rules 124) to automatically determine, without exposing the dealer's down card, whether the dealer's hand after the initial deal, is a natural hand (e.g., a natural 21, or a blackjack).

In one example, the smart card-handling device 102 analyzes the card-draw timestamp data 116 to determine whether a detected card-draw timing (e.g., card draw timing 560 in FIG. 5) for an initial deal matches a burst-timing pattern indicative of an initial deal (i.e., the smart card-handling device 102 performs a burst-pattern analysis). An example method of determining a burst-pattern analysis is described in U.S. Provisional Patent Application No. 63/392,622, which is hereby incorporated by reference in its entirety. In one example, the burst-timing pattern indicates a dealing burst that would occur during an initial deal of blackjack, such as a grouping (i.e., burst) of a given number (e.g., an even number) of card-draw timestamps detected within a short time period relative to each other (e.g., detected within a second of one another), which grouping occurs between two other time tracking events, such as between two long pauses (e.g., see FIG. 5), between a long pause and a dealer input, etc. In response to detection of a burst of card dealing, the smart card-handling device 102 determines (e.g., via analysis of the card-draw timing), a set of timestamps that represent a set of cards drawn for the initial deal (i.e., an initial-deal card set). The smart card-handling device 102 can determine a total number of cards in the initial-deal card set by counting the total number of timestamps in the burst. The smart card-handling device 102 further analyzes game settings 103 to ascertain requirements of the game, such as dealing rules and/or dealing conventions (i.e., dealing rules/conventions 124) as well as other game rules 123. The dealing rules/conventions 124 for the game of blackjack may include, but are not limited to: (a) a known number of cards required to be dealt to each player (i.e., 2 cards to each player in the case of blackjack); (b) a known dealing pattern, which includes a dealing order (e.g., deal from dealer's left to right), a dealing sequence (e.g., deal first card of initial deal to player first, then to dealer—same for second card of initial deal), a dealing constraint (e.g., deal dealer's up card first, down card second); etc. The other game rules 123 may specify a rule as to what constitutes a natural hand (i.e., a natural hand is an initial hand having a rank-value pairing adding up to 21 (e.g., an 11-value rank card paired with a 10-value rank card)). In some embodiments, the game settings 103 may further specify one or more sets of valid natural-hand rank-value pairings (e.g., [A,10], [A, J], [A,Q], [A,K], [10,A], [J,A], [Q,A], and [K,A]), which the smart card-handling device 102 can use for comparison against rank values of the dealer's cards.

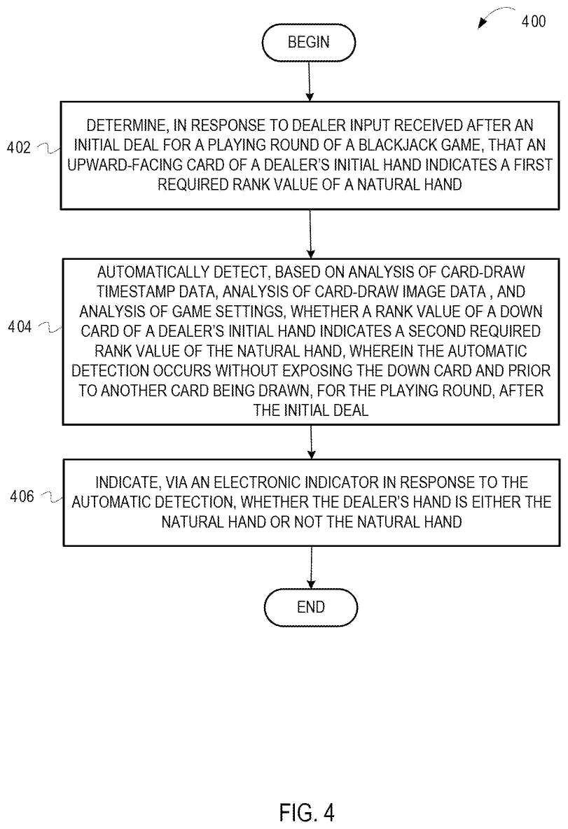

The smart card-handling device 102 can detect the rank values for the dealer's cards by determining card-draw positions for the dealer's cards based on the detected total number of cards in the initial-deal card set, based on the known dealing pattern, and based on the known number of cards required to be dealt to each player. Having determined the card-draw positions for the dealer's cards, the smart card-handling device 102 can access and analyze the portion of the card-draw image data 118 associated with the card-draw positions for the dealer's cards. The smart card-handling device 102 performs electronic card-recognition analysis (or accesses card-recognition data) for the portion of the card-draw image data 118 at the detected card-draw positions for the dealer's card (e.g., see FIGS. 4 and 5 for more details). The smart card-handling device 102 determines, based on the card-recognition data, rank values for the dealer's up card and down card. The smart card-handling device 102 then determines whether the rank values for the dealer's two cards equate to a rank-value pair for a natural hand. In response to the determination of whether the rank values for the dealer's two cards equate to the rank-value pair for the natural hand. the smart card-handling device 102 further notifies (e.g., via one or more electronic indicators), whether the dealer's hand is a natural hand or not a natural hand.

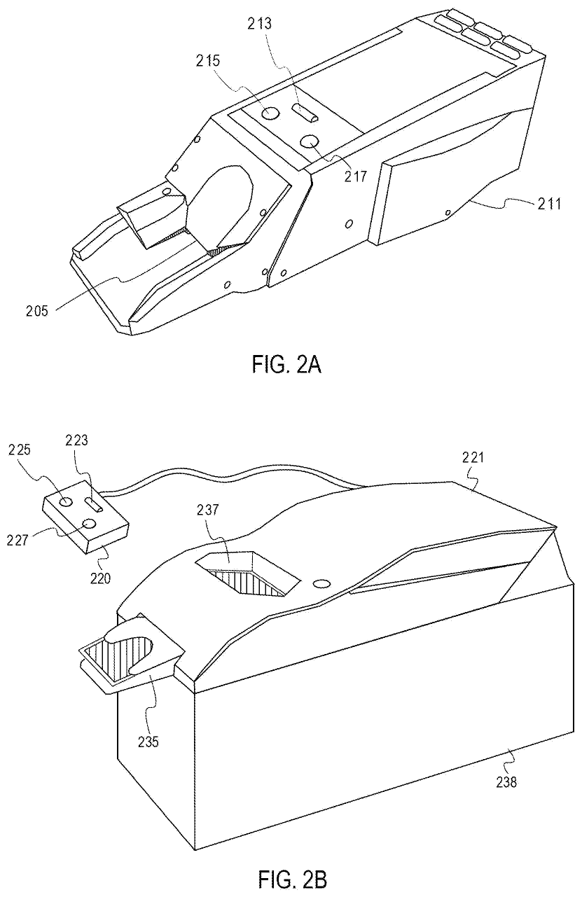

Furthermore, the smart card-handling device 102 includes the input/output devices 113 which can include a dealer input device, such as a button (e.g., button 213 in FIG. 2A or button 223 in FIG. 2B), which the dealer can press to indicate an end of an initial deal. The input/output devices 113 can also include one or more electronic indicators (e.g., indicators 215 and 217 in FIG. 2A or indicators 225 and 227 in FIG. 2B).

In some embodiments, the table 101 and/or the server 150 may store game settings 103 to configure the smart card-handling device 102 for the game. In addition to the dealing rules/conventions 124 and the other game rules 123, the game settings 103 may further include, but are not limited to, a number of cards shuffled, a number of available card decks, card information, artwork, animations, wagering thresholds, and/or other configurable aspects of the smart card-handling device 102, the blackjack game, etc. The game settings 103 may be transmitted to the smart card-handling device 102 in response to associating with the table 101. The smart card-handling device 102 may automatically be configured in accordance with the game settings 103 to reduce necessary time to manually prepare the smart card-handling device 102.

According to some embodiments, the smart card-handling device 102 may be manually prepared with the game settings 103, upon which the table 101 and/or the server 150 may store the game settings 103. If the smart card-handling device 102 should be removed from the table 101, for example, for repair or maintenance, a replacement card-handling device may then be automatically configured in accordance with the stored game settings 103 of the gaming device previously at the table 101 to reduce the preparation time for the replacement card-handling device.

In response to associating the smart card-handling device 102 to the table 101, the smart card-handling device 102 may transmit data (e.g., game data, image data, player data, timing data, card-recognition data, burst data, etc.) to the table 101 to be collected by the server 150 via a communication node. The data may also include data generated by the table 101, such as additional data related to game play or card use, such as the detection of dealt cards and card values at the table 101, detection of bets, detection of players, etc. Some of the additional data can be written to the memory 111 (e.g., written to the card-handling data 112). In some embodiments, the server 150 is configured to periodically collect the data from the table 101 and/or the smart card-handling device 102 (i.e., via polling). In other embodiments, the table 101 and/or the smart card-handling device 102 transmits the data asynchronously to the server 150 for storage and/or analysis. At least some data may remain local to the associated smart card-handling device 102 and/or the table 101 (i.e., the data is not transmitted to the server 150). The data may include, but is not limited to, the game data. The game data includes data associated with the game played at the table 101. Examples of game data may include, but are not limited to, wager amounts, wagered outcomes, payouts, game outcomes, progressive jackpot amounts, number of players, bonus game outcomes, number of cards or decks remaining, number of shuffles, game play events, game sessions, use in a period, and/or other suitable data associated with the game, such some or all portions of the card-handling data 112 (e.g., card-draw timestamp data 116 and card-draw image data 118).

At least some of the data collected by (and transmitted by) the smart card-handling device 102 or table 101 is collected by sensors (e.g., the card-presence sensor 5A and CMOS sensors of the CMOS array 11A, as shown in FIG. 3).

FIGS. 2A and 2B are diagrams of smart card-handling devices in accordance with one or more embodiments. In FIG. 2A, a smart card-handling device 211 is illustrated. The smart card-handling device 211 includes, among other mechanisms, a shoe 205 from which to dispense, or draw cards). The smart card-handling device 211 also includes internal mechanisms to handle cards (e.g., card-handling mechanisms 133, card-recognition system 130, etc.). An example of the smart card-handling device 221 includes the Safe-Shoe™ and Safe-ShoeX™ card-handling products manufactured by Light & Wonder, Inc. In one embodiment, the smart card-handling device 211 also includes input devices, such as a dealer input device (e.g., button 213) which a dealer can use to indicate the end of an initial deal. Furthermore, the smart card-handling device 211 includes one or more indicators, such as a first indicator 215 which indicates an automatic detection of whether the dealer's hand is a natural hand and a second indicator 217 which indicates an automatic detection of whether the dealer's hand is not a natural hand.

In FIG. 2B, a smart card-handling device 221 is illustrated. The smart card-handling device 221 includes, among other mechanisms, a shoe 235 (from which to dispense, or draw cards), a card-return mechanism 237, and a casing 238 containing continuous card-shuffling and card-conveyance mechanisms configured to shuffle the cards entered into the card return mechanism 237 and convey the cards internally, to a card-recognition system (e.g., system 300), then to the shoe 235 (or to a card-recognition system integrated with the shoe 235). An example of the card-handling device 221 is described in more detail in U.S. Pat. No. 9,993,719, issued Jun. 12, 20198 to Krenn, et al., which U.S. Pat. No. 9,993,719 Patent is hereby incorporated by reference in its entirety. In the embodiment illustrated in FIG. 2B, the card-handling device 221 includes an external device 220 (e.g., connected via one of the external interface devices 115, such as via a Universal Serial Bus (USB) device). The external device 220 includes an example dealer input device, such as the button 223, which a dealer can use to indicate the end of an initial deal. Furthermore, the external device 220 includes one or more indicators, such as a first indicator 225 which indicates an automatic detection of whether the dealer's hand is a natural hand and a second indicator 227 which indicates an automatic detection of whether the dealer's hand is not a natural hand. It should be noted, however, that the external device 220 can be incorporated into the casing 238 of the smart card-handling device 221

In some cases, the card-return mechanism 237 includes a card-return receptacle for return of used cards back into a continuous shuffler of the smart card-handling device 221. Hence, in one embodiment, a beginning or an end of a playing round can be determined by a dealer returning cards (e.g., from a previous round) into the card-return receptacle of the card-return mechanism 237. For example, the return of cards to the card-return receptacle indicates the end of a playing round. Hence, the next cards to be drawn from the shoe (of the shuffler) includes only cards used for the next playing round. Thus, the return of cards (from the previous playing round) indicates the beginning point for the initial deal of the next playing round.

FIG. 3 is a schematic diagram showing a card-recognition system 300 in accordance with at least one embodiment. The card-recognition system 300 includes an imaging module 10A, a card-recognition module 20A, a card-handling microprocessor 30A (e.g., a smart-shoe or shuffler microprocessor), and a card presence sensor 5A. The imaging module 10A includes a Complementary Metal Oxide Semiconductor (CMOS) camera that comprises a CMOS sensor array 11A and LED(s) 2A. The CMOS sensor array 11A and the LED(s) 2A are communicatively coupled, for example, via a camera board 12A. The LEDs 2A provide a light source for the CMOS sensor array 11A. Although a white light source is sometimes adequate to capture gray scale data from red and black print on cards, it has been discovered that a green light source is an efficient source of illumination for a black and white CMOS sensor. The card-recognition module 20A includes a field-programmable gate array (FPGA) 4A and a card-recognition microprocessor 3A, which are communicatively coupled, for example, via an FPGA board 22A. The card presence sensor 5A communicates a signal to the card-handling microprocessor 30A when a card is detected in a specific location at which the imaging module 10A can capture an image of the card. In one embodiment, the imaging module 10A is instructed to capture image data of the card face. For example, the card recognition microprocessor 3A instructs the imaging module 10A to capture data using the CMOS sensor array 11A. The imaging module 10A converts sensor output to binary values for card recognition detection. For example, the CMOS sensor array 11A is suitable for capturing printed data from cards. The CMOS sensor array 11A includes sensors that output grayscale values in 8- or 16-bit format. For example, the output of an exemplary CMOS camera (e.g., a black and white camera) can be a series of grayscale output values between 255 (white) and 0 (black) or any other linear or exponential scale. The output can also be a voltage. Signals are converted to binary values either within the sensors of the CMOS sensor array 11A, in a separate hardware device or within the hardware component.

The imaging module 10A sends the image data to the FPGA module 20A to analyze the image data and detect the card value on the card face (e.g., at least the card rank in the case of blackjack). For example, the imaging module 10A sends the output grayscale values to the FPGA module 20A. The FPGA module 20A receives the output grayscale values from the imaging module 10A, then the FPGA 4A performs binary conversion of the grayscale values by a thresholding method where grayscale values below a certain threshold value are assigned a 0 and grayscale value above a specific threshold value are assigned a value of 1. This conversion is possible because color is not needed as a distinguishing factor in determining rank (or suit).

In one embodiment, after performing the binary conversion, the FPGA 4A compares the converted image data (e.g., one or more vector set(s) of image data) with known vectors to identify card rank and suit. In one embodiment, a reference vector set for each suit and each rank is stored in memory associated with the card recognition microprocessor 3A. The stored vector sets are transferred to the FPGA 4a on power up. For example, in one embodiment, the CMOS sensor array 11A provides a representation of the two-dimensional image by providing a continuous series of vectors derived from a single card that are correlated with known reference vectors through the hardware component (e.g., ASIC or FPGA) configured to interpret the sensor signals and the closest correlation results in an identification of the rank (and suit) of the card.

In one embodiment, the card-recognition microprocessor 3A uses a template matching algorithm to identify card values. An exemplary description of a template matching algorithm can be found in the U.S. Pat. No. 8,538,155 Patent referenced previously.

As shown in FIG. 3, the imaging module 10A and the FPGA module 20A are shown as separate, but related units. In other embodiments, however, the imaging module 10A and the logic/intelligence/functions of the FPGA module 20A can be integrated into the single unit. For example, although the FPGA board 22A is a separate construction from the camera board 12A, the functionality of both boards can be combined on one board. Furthermore, the card presence sensor 5A could alternately send a signal directly to the card recognition microprocessor 3A rather than to the card-handling microprocessor 30A.

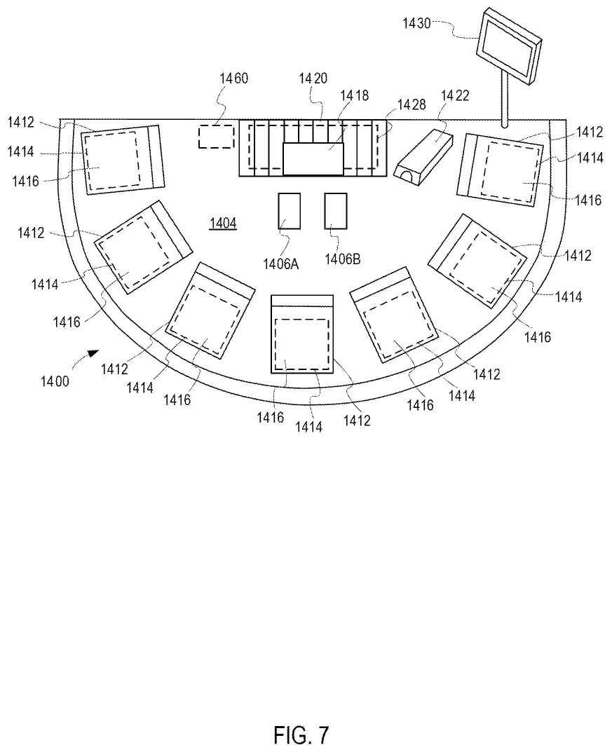

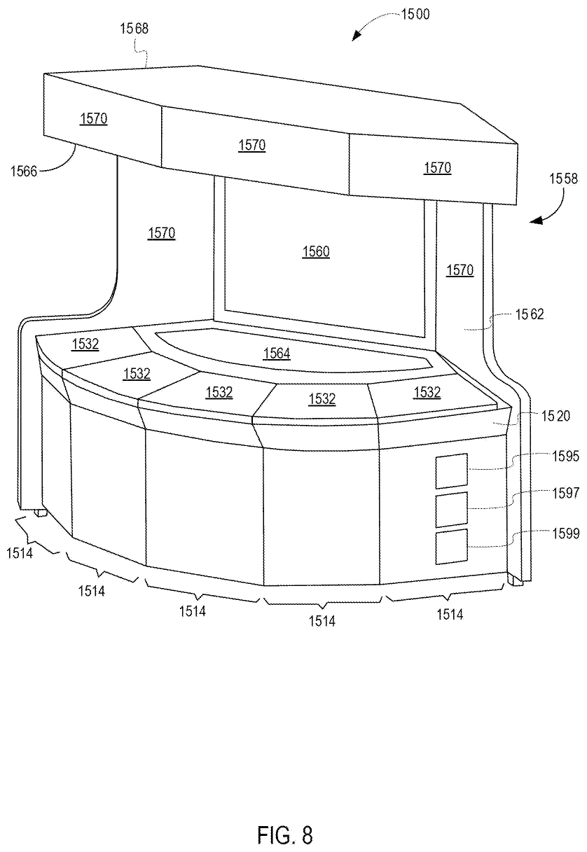

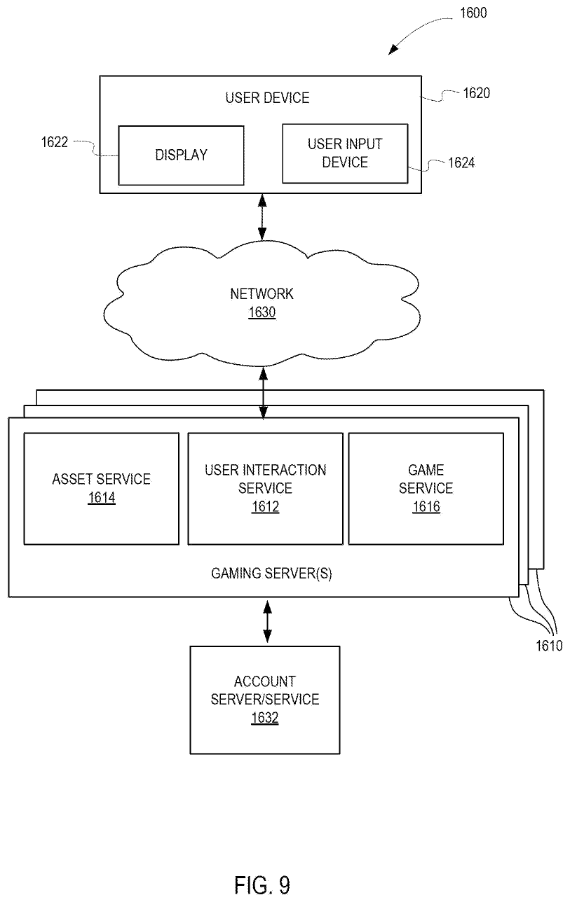

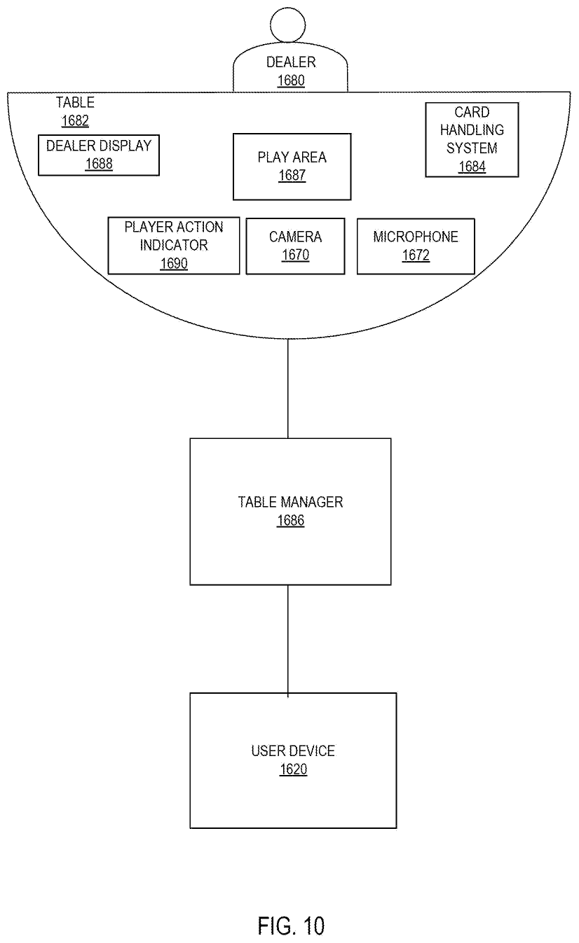

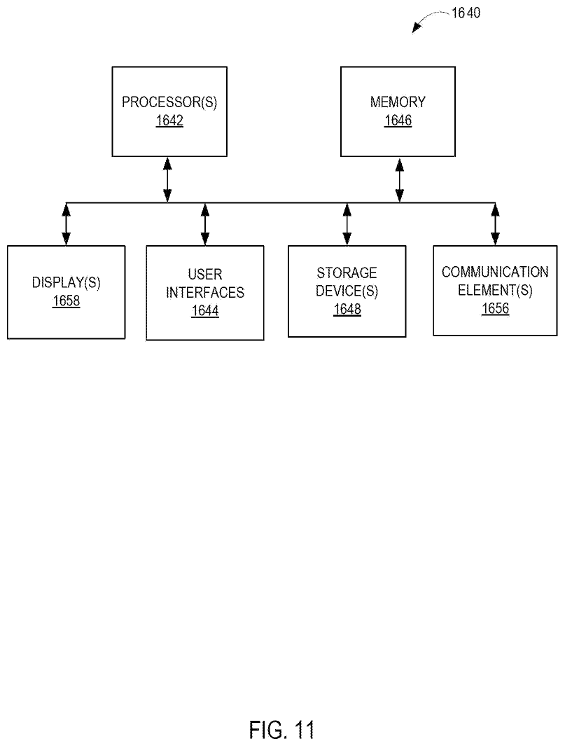

FIG. 4 is a flow diagram of an example flow (400) for automatically determining dealer blackjack from an initial deal based, at least in part, on card-handling data analysis in accordance with at least one embodiment. The description of FIG. 4 will refer to the description of FIG. 1, FIG. 2A, FIG. 2B, FIG. 3, and/or FIG. 5 by way of example. Further, the description of FIG. 4 refers to a “processor” that performs operations associated with the flow 400. It should be noted that the reference to the processor may refer to the same physical processor or it may be one of a set of a plurality of processors. The set of processors may operate in conjunction with each other and may be distributed across one or more various networked devices (e.g., across network(s) 109). The types of processors may include a central processing unit, a graphics processing unit, any combination of processors, etc. In one embodiment, the processor may be included in, or refer to, one or more devices of the network(s) 109, such as any one of the devices connected via a casino network. In one embodiment, the processor may be any one, or more, of the processors described in connection with FIGS. 1 through 3 and FIGS. 5 through 11, including, but not limited to, the card handling device 102 (e.g., the processor(s) 142), the table 101, the server 150, any processor associated with the card-handling devices 211 and 221 described in FIGS. 2A and 2B, any of the microprocessors and/or other elements described in FIG. 3, one or more of the local game processors 1414 or the central game processor 1428 described in FIG. 7, the control processor 1597 described in FIG. 8, a processor associated with the gaming server(s) 1610 described in FIG. 9, a processor associated with any of the elements described in FIG. 10 (e.g., a processor of the table 1682, the card-handling system 1684, the dealer display 1688, the camera 1670, the table manager 1686, etc.), the processor(s) 1642 described in FIG. 11, a processor in another device mentioned herein, any logic or control unit of elements descried herein (e.g., the analysis logic 143), etc.

Referring to FIG. 4, the flow 400 begins at processing block 402, where the processor determines, in response to dealer input received after an initial deal for a playing round of a blackjack game, that an upward-facing card of a dealer's initial hand indicates a first required rank value of a natural hand. For example, referring to FIG. 5, a game of blackjack is being played at a gaming table (e.g., table 501). Table 501 is an example of the table 101 mentioned in FIG. 1. During an initial deal of a playing round, a dealer 525 draws cards (e.g., cards 551-558) from smart card-handling device 211 and deals the cards to each player 541, 542, and 543 according to known game rules and/or known dealing conventions or patterns.

At stage “A,” as each card is dealt, the smart card-handling device 211 generates, stores and/or transmits (e.g., to table 501, to server 110, etc.) card-handling data (e.g., card-handling data 112), which includes the timing data (e.g., card-draw timestamp data 116) and image data (e.g., card-draw image data 118) corresponding to the dealing of the card. For example, the smart card-handling device 211 generates and/or stores, during an initial deal of a blackjack game, timestamp data (e.g., from the card-draw timing 560 of when each card is drawn from the card-handling device 211) and card-draw order data (i.e., the drawing order 570 of the cards). Further, the smart card-handling device 211 stores images (e.g., in card-draw image data 118) of the cards as they are dealt according to the drawing order 570. The card-draw image data 118 includes an appearance of the card's face value captured by an image sensor (e.g., card presence sensor 5A mentioned in FIG. 3) of the smart card-handling device 211 at around the time (e.g., either during, or immediately before) the card was drawn from a shoe of the smart card-handling device 211.

The following paragraphs describe a hypothetical tracking of timing (including, storage of timestamp values) for cards dealt during the initial deal of the game of blackjack.

Prior to the beginning of the initial deal, a long pause 60 occurs in the card-draw timing 560. The long pause 60 occurs during termination of a previous (“old”) playing round while cards are not being drawn from the smart card-handling device 211 (e.g., while the dealer 525 pays wins and removes cards from the table 501 in preparation for an upcoming (“new”) playing round).

After the pause 60, the dealer 525 starts the initial deal for the new playing round.

At a first time (e.g., 21:08:02.10), a first card (e.g., card 551) is drawn and dealt to player 541. Timestamp 561 is recorded. In the example of FIG. 5, card 551 is the Four of Spades. As illustrated in FIG. 5, the face layouts on the drawn cards are shown in a simplified format for the sake of brevity (e.g., showing only one indicia of rank and one indicia of suit), however it should be understood that the face layout of cards can take the form of a standard playing card, having a standard layout of card indicia, including a standard placement of symbols for the rank and suit on the cards, which can appear as indicia in multiple corners of the card as well as indicia in the middle of the card.

At a second time (e.g., 21:08:02.30), a second card (e.g., card 552) is drawn and dealt to player 542. Timestamp 562 is recorded. In the example of FIG. 5, card 552 is the King of Diamonds.

At a third time (e.g., 21:08:02.48), a third card (e.g. card 553) is drawn and dealt to player 543. Timestamp 563 is recorded. In the example of FIG. 5, card 553 is the Nine of Hearts.

At a fourth time (e.g., 21:08:02.59) a fourth card (e.g., card 554) is drawn and dealt to a dealer station. Timestamp 564 is recorded. The card 554 is also referred to herein as the dealer's upward-facing card or up card. In the example of FIG. 5, card 554 is the Ace of Diamonds (an 11-value rank card).

At a fifth time (e.g., 21:08:03.18), a fifth card (e.g., card 555) is drawn and dealt to player 541. Timestamp 565 is recorded. In the example of FIG. 5, card 555 is the Six of Hearts.

At a sixth time (e.g., 21:08:03.38), a sixth card 556 is drawn and dealt to player 542. Timestamp 566 is recorded. In the example of FIG. 5, card 556 is the Eight of Clubs.

At a seventh time (e.g., 21:08:03.56), a seventh card (e.g., card 557) is drawn and dealt to player 543. Timestamp 567 is recorded. In the example of FIG. 5, card 557 is the Three of Diamonds.

At an eighth time (e.g., 21:08:04:15), an eighth card (e.g., card 558) is drawn and dealt to the dealer station. Timestamp 568 is recorded. The card 558 is dealt face down. Card 558 is referred to herein as the dealer's downward-facing card or down card. In the example of FIG. 5, card 558 is the Queen of Spades (a 10-value rank card). However, the card 558 is not revealed to the players during the initial deal. Rather it is dealt, to the dealer's hand, facing downward. The card-handling device 211 captures and stores image data of the face value of the card 558 for future reference (e.g., for card-recognition, for timestamp analysis, etc.).

As soon as the dealer is done with the initial deal, the dealer 525 indicates, via user input (e.g., via a press of the button 213), that the initial deal ends. A long pause 69 then occurs in the card-draw timing 560, which corresponds to the dealer 525 pausing the dealing after the initial deal.

In the above example, the timestamp data shows that eight cards were quickly dealt, generally within one second of each other. During the drawing of the cards from the card-handling device 211, the dealer 525 draws the cards according to the drawing order 570, whereby one card is drawn after another in the drawing order 570. For example, card 551 was drawn first during the initial deal, hence card 551 has a first position (i.e., position 571) within the drawing order 570. Card 552 was drawn second, hence it has a second position in the drawing order 570. Card 553 was drawn third, hence it has a third position in the drawing order 570. Card 554 was drawn fourth, hence it has a fourth position (i.e., position 574) in the drawing order 570. Card 555 was drawn fifth, hence it has a fifth position in the drawing order 570. Card 556 was drawn sixth, hence it has a sixth position in the drawing order 570. Card 557 was drawn seventh, hence it has a seventh position in the drawing order 570. Finally, card 558 was drawn eighth, hence it has an eighth position (i.e., position 578) in the drawing order 570. During the drawing, the smart card-handling device 211 keeps track of the cards that were drawn (e.g., stores image data) according to the drawing order 570. For example, the smart card-handling device 211 keeps tracks of a series of images taken in association with the drawing of the cards and stores them according to the drawing order 570. In one embodiment, the drawing order 570 can be determined based on the times indicated by the time stamps of the card-draw timing 560.

The smart card-handling device 211 determines when the dealer's upward-facing card indicates a first required rank-value of a natural hand. The first required rank-value constitutes either a card having an “11-value” rank card (i.e., an “Ace” card)) or a card having a “10-value” rank (e.g., either a “10” card, a “Jack” card, a “Queen” card, or a “King” card). A natural hand (e.g., a natural 21) requires at least one card with an “11-value” rank and one card with a “10-value” rank. For standard blackjack rules, only one card is the 11-value card (i.e., the Ace), however many cards can be the 10-value card (e.g., the Ten cards as well as any face cards). Thus, the Ace, combined with any of the other 10-value cards, represents a rank-value pairing that is required for a natural hand. If the upward-facing card indicates an Ace, then the first required rank value of a valid rank-value pairing constitutes the 11-value rank. Consequently, to have a value rank-value pairing for a natural hand, the second required rank value would need to be a 10-value rank. On the other hand, if the upward-facing card indicates a 10-value rank, then the first required rank value of a valid rank-value pairing constitutes the 10-value rank; consequently, to have a valid rank-value pairing for a natural hand, the second required rank value would need to be an 11-value rank. In the example of FIG. 5, the card-handling device 211 determines that the dealer's upward-facing card (i.e., card 554) has as an 11-value rank (i.e., the dealer's up card is the Ace of Diamonds, hence an 11-value rank). Thus, the 11-value rank is referred to as the first required rank value in this example. The second required rank value (which is determined at stage “F” described further below), thus must be a 10-value rank in order for the dealer's hand to be the natural hand.

In one embodiment, the card-handling device 211 determines whether the dealer's upward-facing card indicates a first required rank-value of a natural hand in response to receiving dealer input (e.g., user input from the dealer). For example, at stage “B,” the dealer input is detected when the dealer 525 pushes the button 213 (immediately after the initial deal is complete). It should be noted that the button 213 is illustrated as a mechanical button coupled to the smart card-handling device 211. However, the button 213 could instead be a button on a touch-screen interface, a remote control button, an external button connected via USB, etc. In another embodiment, the dealer input can be another physical action, such as inserting the initial card hand into a card reader having an internal switch that detects when the card hand is inserted, so that the card reader can detect the value of the down card. Hence, the dealer doesn't have to read (or otherwise) evaluate the down card as the card reader would instead read the card value.

In some embodiments, the smart card-handling device 211 can automatically detect an end of the initial deal via indirect dealer input. For instance, in one embodiment, the smart card-handling device 211 utilizes one or more tracking systems in addition to (or instead of) relying on a dealer's direct input to indicate the end of the initial deal. For example, the table 501 can be equipped with the i-Table® product, or the TableView™ product, both from Light & Wonder, Inc., or another automated table tracking system which includes electronic playing terminals (e.g., to track player data) or environmental sensors (e.g., a camera 531, light detection and ranging (LIDAR) devices, or other light-detecting sensors). The smart card-handling device 211 can incorporate table tracking system components to detect (e.g., based on computer vision, machine-learning models, or other automated image analysis) when the initial deal is completed, whether the dealer has a 10-value rank card or an 11-value rank as the face-up card. For example, a machine-learning model can be trained to detect a dealing action to a dealer station (i.e., detect when cards are dealt to a dealer station, detect when an up card is dealt, detect when a down card is dealt, etc.). For example, the machine-learning model can detect, as soon as the dealer station receives a down card, that the initial deal is completed. In another embodiment, the machine-learning model can be trained to detect one or more particular dealing patterns indicative of an initial deal. Furthermore, as the dealer 525 deals the cards 151-158, the smart card-handling device 211 can capture images (or other data) of the dealt cards at the gaming table and recognize card value (e.g., rank values) of dealt cards based on machine-learning training.

Referring momentarily back to FIG. 4, the flow 400 continues at processing block 404, where the processor automatically detects, based on an electronic analysis of card-draw timestamp data, an electronic analysis of card-draw image data, and an electronic analysis of game settings, whether a rank value of a down card of a dealer's initial hand indicates a second required rank value of the natural hand. The automatic detection occurs without exposing the down card and prior to another card being drawn, for the playing round, after the initial deal.

For example, referring to FIG. 5, at stage “C,” in response to the dealer input (detected at stage “B”), the smart card-handling device 211 detects, via electronic analysis of card-draw timestamp data, a burst pattern indicative of an initial deal of the blackjack game. For instance, the smart card-handling device 211 compares the pattern of timestamps from the card-draw timing 560 to a burst-timing pattern 580 for an initial deal. For example, the burst-timing pattern 580 comprises a pattern (or sequence) that includes (a) a set of an even number of timestamps that occur within about one second of one another (the burst), (b) a first pause that precedes the burst, and (c) a second pause that follows the burst. The smart card-handling device 211, for example, detects that the timestamp pattern of the card-draw timing 560 matches the burst-timing pattern 580 in that the card-draw timing 560 indicates a first pause (i.e., pause 60) that precedes a burst of timestamps (i.e., timestamps 561-568), followed by a second a pause (i.e., pause 69) after the burst. In some embodiments, the burst-timing pattern 580 may be a different pattern, such as a single pause, followed by a burst of timestamps, followed by any other event trigger (e.g., indirect dealer input, dealing action detected by a machine-learning model, etc.).

In some embodiments, the smart card-handling device 211 can utilize machine-learning models to perform one or more parts of the burst analysis. For example, the dealer may deal some cards during the initial deal and pause momentarily, such as to fix a bet. After the pause, the dealer continues to complete the initial deal. In some embodiments, the smart card-handling device 211 detects the burst pattern and also detects the momentary pause as still being a part of the burst pattern (e.g., detects that the temporary pause occurs within a few seconds of the other time draw stamps of the burst). Thus, the machine-learning model can be trained to detect a relative timing of the dealing pattern as well as to watch, and adjust for, minor variations to the timing, and/or to adapt to other such dealing parameters. For example, the dealing parameters can include parameters that assess (a) how long a current deal takes in comparison to the length of previous initial deals, (b) how long a current pause in dealing takes based on how long of a pause is usually taken after the initial deal, (c) how long a current pause in dealing takes in response to occurrence other events, (d) a pattern or successive patterns of bursts, (e) specific dealer information such as a dealing profile or dealing pattern of a specific dealer, (f) other event data (e.g., based on analysis of computer vision systems at the table 501), etc.

Furthermore, it should be noted that the opening burst is only one of several bursts in timing that could occur during a playing round. The opening burst is the first burst detected during the playing round for the initial deal. Other bursts may include bursts of relatively rapid card dealing of additional cards after the pause 69, such as bursts to deal hit cards to a specific player.

The example of blackjack and an opening burst of dealt cards is illustrative, it should be clear that at least some of the disclosed embodiments can apply equally to any other game that includes a specific dealing pattern of cards identifiable by timestamps associated with each of the cards dealt during play of the card game to identify one or more rounds of play.

Furthermore, embodiments can vary as to what and where data collection, reporting, and analysis are done. For example, in one embodiment, smart card-handling device 211 may perform little or no analysis of collected data; rather, the table 501 and/or the server 150 may perform some or all of the data analysis (or another computer that eventually receives or has access to the data). In another embodiment, however, the card-handling device 211 performs some or all of the analysis of the collected data.

Referring back to FIG. 5, if the burst-timing pattern is detected for the initial deal, then the processor has determined that an initial deal has just occurred. Consequently, at stage “D” the smart card-handling device 211 determines, based on analysis of the card-draw timestamp data 116, that the burst indicates eight time stamps (i.e., timestamps 561-568), which also indicates an initial-deal card set (e.g., the initial-deal card set is the set of eight cards 551-558). More specifically, the smart card-handling device 211 uses the number of timestamps in the initial-deal card set as a measure of the total number of cards that were dealt during the initial deal. Furthermore, based on the card-draw timing 560 for the initial-deal card set, the smart card-handling device 211 determines the drawing order 570 for the initial-deal card set, including the card-draw positions for the initial-deal card set (e.g., determines that the first position 517 is associated with the first card 551, determines that the fourth position 574 is associated with the fourth card 554, determines that the eighth position 578 is associated with the eighth card 558, etc.). In some embodiments, the smart card-handling device 211 can determine the total number of cards dealt during the initial deal by finding the beginning timestamp of the detected burst. The beginning timestamp of the detected burst is the timestamp 561 that occurs after the pause 60. The smart card-handling device 211 then finds the ending timestamp of the detected burst. The ending timestamp of the detected burst is the timestamp 568 that occurred just before the dealer input. The timestamps 561 and 568 bookend the initial-deal card set. The timestamps 562, 563, 564, 565, 566, and 567, which occur between the timestamp 561 and the timestamp 568, comprise additional timestamps for the initial-deal card set. The smart card-handling device 211 counts up the number of timestamps from 561 through 568, resulting in the number eight (8). Because one timestamp correlates to one card dealt, then the number of timestamps equates to the number of cards drawn and dealt. Thus, the total number of cards dealt during initial round is eight (8), namely cards 551-558.

In some embodiments, the smart card-handling device 211 can determine the total number of cards without a burst analysis. For example, in some embodiments, the card-handling device can determine how many cards were dealt during the initial deal based on multiple dealer inputs and/or via analysis of dealer actions. For example, the dealer can press a button a first time at the begging of dealing the initial deal. The dealer can press a button a second time to indicate the end of the initial deal. Hence, the card-handling device can, during the two button presses, count the number cards that were dealt.

At stage “E” the smart card-handling device 211 determines, based on analysis of game settings and analysis of card-draw image data, a, first required rank-value of the dealer's up card. For instance, the smart card-handling device 211 determines, from analysis of dealing rules/conventions 124, a known position of dealer's dealt cards relative to that of other player's cards according to the known dealing pattern. In some embodiments, game settings may vary based on different rules, hence the dealing pattern can vary. For example, in a first scenario, one dealing rule/convention may specify a dealing pattern that requires that the dealer's up card is the first card dealt to the dealer's hand during the initial deal. In a second scenario, however, another dealing rule/convention may specify a dealing pattern that requires the dealer's up card to be the last card (i.e. the second card) dealt to the dealer's hand during the initial deal. The example of FIG. 5 illustrates the first scenario, where the dealing rule/convention requires a dealing pattern where the dealer's up card is the first card dealt to the dealer's hand (i.e., card 554). In that scenario, the smart card-handling device 211 determines (e.g., from analysis of the other game rules 123) a number of cards required to be dealt to each player during initial round (i.e., 2 cards dealt to each player). The smart-card-handling device then determines the dealer's up-card draw position by dividing the total number of cards dealt during initial round (e.g., 8) by the number of cards required to be dealt to each player (i.e., 2). The result of the division is the up-card draw position (i.e., the result is the number “4,” meaning the fourth position 574) within the drawing order 570 for the cards in the initial deal. The smart card-handling device stores the up-card draw position in memory 111.

In the example of the second scenario, for a dealing pattern that requires that dealer's up card is last card dealt to the dealer's hand, then the smart card-handling device 211 would determine the up-card draw position to be the last card drawn in the drawing order 570. For example, given that the smart card-handling device 211 detects the initial deal (e.g., in response to dealer input, via burst analysis, etc.), then the smart card-handling device 211 also knows which was the last card dealt in the initial deal. For example, the last card dealt in the initial deal is the card dealt right before the dealer provided the dealer input, (e.g., the last card drawn and dealt during the initial deal before the dealer pressed the button 213). The last card drawn and dealt in the drawing order 570 was the card in the eighth position 578. Therefore, the smart card-handling device 211 detects the up-card draw position as at the eighth position 578 of the drawing order 570. The smart card-handling device stores the up-card draw position in memory 111.

After determining the up-card draw position, the smart card-handling device 211 determines the first-required rank-value of the card at the up-card draw position. For example, the smart card-handling device 211 can perform analysis of the card-draw image data 118 for the card at the up-card draw position and, via a card-recognition system (e.g., card-recognition system 130 or 300), detect a first rank value of the up card. The processor stores the first rank value of the up card as the first-required rank-value for the natural hand. For example, in FIG. 5, the smart card-handling device 211 determines that the rank value for the card 554 (at the up-card draw position—the fourth position 574), is an 11-value rank card (i.e., an Ace)). Thus, the smart card-handling device stores the first rank value in memory 111 for future reference.

At stage “F” the smart card-handling device 211 determines whether dealer's down card has second-required rank value for natural hand. The smart card-handling device 211 can determine whether the dealer's down card has the second-required rank value based on the determination of the first required rank-value, as well as based on analysis of card-draw image data and/or analysis of game settings. For example, in FIG. 5, the smart card-handling device 211 determines the down-card draw position to be the last card drawn in the drawing order 570. Therefore, the smart card-handling device 211 detects the down-card draw position as at the eighth position 578 of the drawing order 570. The smart card-handling device stores the down-card draw position in memory 111. In an example (not shown) where the dealing rules/conventions 124 specify a dealing pattern where the dealer's down card is the first card dealt to the dealer's hand (e.g., card 554), then the smart card-handling device 211 can determine (e.g., from analysis of the other game rules 123) the number of cards required to be dealt to each player during the initial deal (i.e., 2 cards dealt to each player). The smart-card-handling device 211 can then determine the dealer's down-card draw position by dividing the total number of cards dealt during initial round (e.g., 8) by the number of cards required to be dealt to each player (i.e., 2). The result of the division would be the down-card draw position (i.e., the fourth position 574 within the drawing order 570).

After the smart card-handling device 211 detects the dealer' down-card draw position, the smart card-handling device 211 detects (e.g., via card-recognition analysis) the card rank value at the down-card draw position (e.g., detects the card rank value of the down card as a 10-value rank card—the Queen of Spades). The card rank value of the down card is referred to as the second rank value.

Furthermore, the smart card-handling device 211 determines (e.g., based on comparison of second rank value to first rank value and based on game rule requirements for a natural hand), whether the second rank value equates to a second required-rank value for a natural hand. For instance, in response to detecting the first rank value, the smart card-handling device 211 can determine whether the second rank value is a second-required rank value (and hence determine whether the dealer's initial hand is a natural hand) if the first rank value (e.g., the 11-value rank) plus the second rank value (e.g., 10-value rank) equals to a combined total of twenty-one (“21”). If the combined total is not equal to 21, then the second rank value is not the second-required rank value (and hence the smart card-handling device 211 determines that the dealer's initial hand is not a natural hand).

Referring back to FIG. 4, the flow 400 continues at processing block 406, where the processor indicates, via an electronic indicator in response to the automatic detection and analysis of the first and second rank values, whether the dealer's hand is either the natural hand or not the natural hand. For example, in FIG. 5, at stage “G” the smart card-handling device 211 electronically presents a notification regarding the dealer's initial hand being a natural hand. For example, the smart card-handling device 211 can present a first type of electronic notification if the dealer's initial hand equates to a natural hand. The first type of electronic notification indicates that the round is over. For instance, the indicator 215 can light up a light emitting diode (LED) having a specific configurable color (e.g., red) to indicate a dealer blackjack (i.e., to indicate that the dealer has a natural hand), hence that the current playing round is over. Further, the smart card-handling device 211 can present a second type of electronic notification if the dealer's initial hand equates to a natural hand. The second type of electronic notification indicates that the round is not over. For instance, the indicator 217 can light up an LED with a different configurable color (e.g., green) to indicate that the dealer does not have a natural hand, hence the current playing round can continue. In one embodiment, a display 537 can function as an electronic indicator of whether the dealer has a natural hand. For example, the display 537 indicates the face values of the dealer's initial hand and also specifies (e.g., to the participants at the table) that the combination is a natural hand.

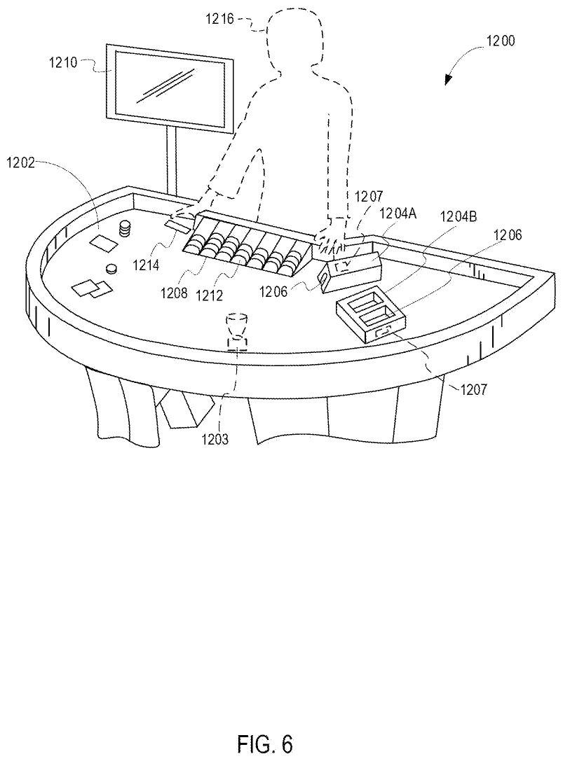

FIG. 6 is a perspective view of an embodiment of a gaming table 1200 (which may be configured as the gaming table 101 or the gaming table 501) for implementing wagering games in accordance with this disclosure. The gaming table 1200 may be a physical article of furniture around which participants in the wagering game may stand or sit and on which the physical objects used for administering and otherwise participating in the wagering game may be supported, positioned, moved, transferred, and otherwise manipulated. For example, the gaming table 1200 may include a gaming surface 1202 (e.g., a table surface) on which the physical objects used in administering the wagering game may be located. The gaming surface 1202 may be, for example, a felt fabric covering a hard surface of the table, and a design, conventionally referred to as a “layout,” specific to the game being administered may be physically printed on the gaming surface 1202. As another example, the gaming surface 1202 may be a surface of a transparent or translucent material (e.g., glass or plexiglass) onto which a projector 1203, which may be located, for example, above or below the gaming surface 1202, may illuminate a layout specific to the wagering game being administered. In such an example, the specific layout projected onto the gaming surface 1202 may be changeable, enabling the gaming table 1200 to be used to administer different variations of wagering games within the scope of this disclosure or other wagering games. In either example, the gaming surface 1202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 1202 may be configured as any table surface described herein.

In some embodiments, the gaming table 1200 may include a display 1210 separate from the gaming surface 1202. The display 1210 may be configured to face players, prospective players, and spectators and may display, for example, information randomly selected by a shuffler device and also displayed on a display of the shuffler device; rules; pay tables; real-time game status, such as wagers accepted and cards dealt; historical game information, such as amounts won, amounts wagered, percentage of hands won, and notable hands achieved; the commercial game name, the casino name, advertising and other instructions and information related to the wagering game. The display 1210 may be a physically fixed display, such as an edge lit sign, in some embodiments. In other embodiments, the display 1210 may change automatically in response to a stimulus (e.g., may be an electronic video monitor).

The gaming table 1200 may include particular machines and apparatuses configured to facilitate the administration of the wagering game. For example, the gaming table 1200 may include one or more card-handling devices 1204A, 1204B. The card-handling device 1204A may be, for example, a shoe from which physical cards 1206 from one or more decks of intermixed playing cards may be withdrawn, one at a time. Such a card-handling device 1204A may include, for example, a housing in which cards 1206 are located, an opening from which cards 1206 are removed, and a card-presenting mechanism (e.g., a moving weight on a ramp configured to push a stack of cards down the ramp) configured to continually present new cards 1206 for withdrawal from the shoe.

In some embodiments in which the card-handling device 1204A is used, the card-handling device 1204A may include a random number generator 151 and the display 152, in addition to or rather than such features being included in a shuffler device. In addition to the card-handling device 1204A, the card-handling device 1204B may be included. The card-handling device 1204B may be, for example, a shuffler configured to select information (using a random number generator), to display the selected information on a display of the shuffler, to reorder (either randomly or pseudo-randomly) physical playing cards 1206 from one or more decks of playing cards, and to present randomized cards 1206 for use in the wagering game. Such a card-handling device 1204B may include, for example, a housing, a shuffling mechanism configured to shuffle cards, and card inputs and outputs (e.g., trays). Shufflers may include card recognition capability that can form a randomly ordered set of cards within the shuffler. The card-handling device 1204 may also be, for example, a combination shuffler and shoe in which the output for the shuffler is a shoe.

In some embodiments, the card-handling device 1204 may be configured and programmed to administer at least a portion of a wagering game being played utilizing the card-handling device 1204. For example, the card-handling device 1204 may be programmed and configured to randomize a set of cards and deliver cards individually for use according to game rules and player and or dealer game play elections. More specifically, the card-handling device 1204 may be programmed and configured to, for example, randomize a set of six complete decks of cards including one or more standard 52-card decks of playing cards and, optionally, any specialty cards (e.g., a cut card, bonus cards, wild cards, or other specialty cards). In some embodiments, the card-handling device 1204 may present individual cards, one at a time, for withdrawal from the card-handling device 1204. In other embodiments, the card-handling device 1204 may present an entire shuffled block of cards that are transferred manually or automatically into a card dispensing shoe 1204. In some such embodiments, the card-handling device 1204 may accept dealer input, such as, for example, a number of replacement cards for discarded cards, a number of hit cards to add, or a number of partial hands to be completed. In other embodiments, the device may accept a dealer input from a menu of game options indicating a game selection, which will select programming to cause the card-handling device 1204 to deliver the requisite number of cards to the game according to game rules, player decisions and dealer decisions. In still other embodiments, the card-handling device 1204 may present the complete set of randomized cards for manual or automatic withdrawal from a shuffler and then insertion into a shoe. As specific, nonlimiting examples, the card-handling device 1204 may present a complete set of cards to be manually or automatically transferred into a card dispensing shoe, or may provide a continuous supply of individual cards.

In another embodiment, the card handling device may be a batch shuffler, such as by randomizing a set of cards using a gripping, lifting, and insertion sequence.

In some embodiments, the card-handling device 1204 may employ a random number generator device to determine card order, such as, for example, a final card order or an order of insertion of cards into a compartment configured to form a packet of cards. The compartments may be sequentially numbered, and a random number assigned to each compartment number prior to delivery of the first card. In other embodiments, the random number generator may select a location in the stack of cards to separate the stack into two sub-stacks, creating an insertion point within the stack at a random location. The next card may be inserted into the insertion point. In yet other embodiments, the random number generator may randomly select a location in a stack to randomly remove cards by activating an ejector.

Regardless of whether the random number generator (or generators) is hardware or software, it may be used to implement specific game administrations methods of the present disclosure.

The card-handling device 1204 may simply be supported on the gaming surface 1202 in some embodiments. In other embodiments, the card-handling device 1204 may be mounted into the gaming table 1202 such that the card-handling device 1204 is not manually removable from the gaming table 1202 without the use of tools. In some embodiments, the deck or decks of playing cards used may be standard, 52-card decks. In other embodiments, the deck or decks used may include cards, such as, for example, jokers, wild cards, bonus cards, etc. The shuffler may also be configured to handle and dispense security cards, such as cut cards.

In some embodiments, the card-handling device 1204 may include an electronic display 1207 for displaying information related to the wagering game being administered. The electronic display 1207 may display a menu of game options, the name of the game selected, the number of cards per hand to be dispensed, acceptable amounts for other wagers (e.g., maximums and minimums), numbers of cards to be dealt to recipients, locations of particular recipients for particular cards, winning and losing wagers, pay tables, winning hands, losing hands, and payout amounts. In other embodiments, information related to the wagering game may be displayed on another electronic display, such as, for example, the display 1210 described previously.

The type of card-handling device 1204 employed to administer embodiments of the disclosed wagering game, as well as the type of card deck employed and the number of decks, may be specific to the game to be implemented. Cards used in games of this disclosure may be, for example, standard playing cards from one or more decks, each deck having cards of four suits (clubs, hearts, diamonds, and spades) and of rankings ace, king, queen, jack, and ten through two in descending order. As a more specific example, six, seven, or eight standard decks of such cards may be intermixed. Typically, six or eight decks of 52 standard playing cards each may be intermixed and formed into a set to administer a blackjack or blackjack variant game. After shuffling, the randomized set may be transferred into another portion of the card-handling device 1204B or another card-handling device 1204A altogether, such as a mechanized shoe capable of reading card rank and suit.

The gaming table 1200 may include one or more chip racks 1208 configured to facilitate accepting wagers, transferring lost wagers to the house, and exchanging monetary value for wagering elements 1212 (e.g., chips). For example, the chip rack 1208 may include a series of token support rows, each of which may support tokens of a different type (e.g., color and denomination). In some embodiments, the chip rack 1208 may be configured to automatically present a selected number of chips using a chip-cutting-and-delivery mechanism. In some embodiments, the gaming table 1200 may include a drop box 1214 for money that is accepted in exchange for wagering elements or chips 1212. The drop box 1214 may be, for example, a secure container (e.g., a safe or lockbox) having a one-way opening into which money may be inserted and a secure, lockable opening from which money may be retrieved. Such drop boxes 1214 are known in the art, and may be incorporated directly into the gaming table 1200 and may, in some embodiments, have a removable container for the retrieval of money in a separate, secure location.

When administering a wagering game in accordance with embodiments of this disclosure, a dealer 1216 may receive money (e.g., cash) from a player in exchange for wagering elements 1212. The dealer 1216 may deposit the money in the drop box 1214 and transfer physical wagering elements 1212 to the player. As part of the method of administering the game, the dealer 1216 may accept one or more initial wagers from the player, which may be reflected by the dealer 1216 permitting the player to place one or more wagering elements 1212 or other wagering tokens (e.g., cash) within designated areas on the gaming surface 1202 associated with the various wagers of the wagering game. Once initial wagers have been accepted, the dealer 1216 may remove physical cards 1206 from the card-handling device 1204 (e.g., individual cards, packets of cards, or the complete set of cards) in some embodiments. In other embodiments, the physical cards 1206 may be hand-pitched (i.e., the dealer 1216 may optionally shuffle the cards 1206 to randomize the set and may hand-deal cards 1206 from the randomized set of cards). The dealer 1216 may position cards 1206 within designated areas on the gaming surface 1202, which may designate the cards 1206 for use as individual player cards, community cards, or dealer cards in accordance with game rules. House rules may require the dealer to accept both main and secondary wagers before card distribution. House rules may alternatively allow the player to place only one wager (i.e., the second wager) during card distribution and after the initial wagers have been placed, or after card distribution but before all cards available for play are revealed.

In some embodiments, after dealing the cards 1206, and during play, according to the game rules, any additional wagers (e.g., the play wager) may be accepted, which may be reflected by the dealer 1216 permitting the player to place one or more wagering elements 1212 within the designated area (i.e., area 124) on the gaming surface 1202 associated with the play wager of the wagering game. The dealer 1216 may perform any additional card dealing according to the game rules. Finally, the dealer 1216 may resolve the wagers, award winning wagers to the players, which may be accomplished by giving wagering elements 1212 from the chip rack 1208 to the players, and transferring losing wagers to the house, which may be accomplished by moving wagering elements 1212 from the player designated wagering areas to the chip rack 1208.

FIG. 7 is a top view of a suitable table 1400 configured for implementing wagering games according to this disclosure. The table 1400 may include a playing surface 1404. The table 1400 may include electronic player stations 1412. Each player station 1412 may include a player interface 1416, which may be used for displaying game information (e.g., graphics illustrating a player layout, game instructions, input options, wager information, game outcomes, etc.) and accepting player elections. The player interface 1416 may be a display screen in the form of a touch screen, which may be at least substantially flush with the playing surface 1404 in some embodiments. Each player interface 1416 may be operated by its own local game processor 1414 (shown in dashed lines), although, in some embodiments, a central game processor 1428 (shown in dashed lines) may be employed and may communicate directly with player interfaces 1416. In some embodiments, a combination of individual local game processors 1414 and the central game processor 1428 may be employed. Each of the processors 1414 and 1428 may be operably coupled to memory including one or more programs related to the rules of game play at the table 1400.

A communication device 1460 may be included and may be operably coupled to one or more of the local game processors 1414, the central game processor 1428, or combinations thereof, such that information related to operation of the table 1400, information related to the game play, or combinations thereof may be communicated between the table 1400 and other devices through a suitable communication medium, such as, for example, wired networks, Wi-Fi networks, and cellular communication networks.

The table 1400 may further include additional features, such as a dealer chip tray 1420, which may be used by the dealer to cash players in and out of the wagering game, whereas wagers and balance adjustments during game play may be performed using, for example, virtual chips (e.g., images or text representing wagers). For embodiments using physical cards 1406a and 1406b, the table 1400 may further include a card-handling device 1422 such as a card shoe configured to read and deliver cards that have already been randomized. For embodiments using virtual cards, the virtual cards may be displayed at the individual player interfaces 1416. Physical playing cards designated as “common cards” may be displayed in a common card area.

The table 1400 may further include a dealer interface 1418, which, like the player interfaces 1416, may include touch screen controls for receiving dealer inputs and assisting the dealer in administering the wagering game. The table 1400 may further include an upright display 1430 configured to display images that depict game information, pay tables, hand counts, historical win/loss information by player, and a wide variety of other information considered useful to the players. The upright display 1430 may be double sided to provide such information to players as well as to casino personnel.

Although an embodiment is described showing individual discrete player stations, in some embodiments, the entire playing surface 1404 may be an electronic display that is logically partitioned to permit game play from a plurality of players for receiving inputs from, and displaying game information to, the players, the dealer, or both.

FIG. 8 is a perspective view of another embodiment of a suitable electronic multi-player table 1500 configured for implementing wagering games according to the present disclosure utilizing a virtual dealer. The table 1500 may include player positions 1514 arranged in a bank about an arcuate edge 1520 of a video device 1558 that may comprise a card screen 1564 and a virtual dealer screen 1560. The dealer screen 1560 may display a video simulation of the dealer (i.e., a virtual dealer) for interacting with the video device 1558, such as through processing one or more stored programs stored in memory 1595 to implement the rules of game play at the video device 1558. The dealer screen 1560 may be carried by a generally vertically extending cabinet 1562 of the video device 1558. The substantially horizontal card screen 1564 may be configured to display at least one or more of the dealer's cards, any community cards, and each player's cards dealt by the virtual dealer on the dealer screen 1560.

Each of the player positions 1514 may include a player interface area 1532 configured for wagering and game play interactions with the video device 1558 and virtual dealer. Accordingly, game play may be accommodated without involving physical playing cards, poker chips, and live personnel. The action may instead be simulated by a control processor 1597 interacting with and controlling the video device 1558. The control processor 1597 may be programmed, by known techniques, to implement the rules of game play at the video device 1558. As such, the control processor 1597 may interact and communicate with display/input interfaces and data entry inputs for each player interface area 1532 of the video device 1558. Other embodiments of tables and gaming devices may include a control processor that may be similarly adapted to the specific configuration of its associated device.

A communication device 1599 may be included and operably coupled to the control processor 1597 such that information related to operation of the table 1500, information related to the game play, or combinations thereof may be communicated between the table 1500 and other devices, such as a central server, through a suitable communication medium, such, as, for example, wired networks, Wi-Fi networks, and cellular communication networks.

The video device 1558 may further include banners communicating rules of play and the like, which may be located along one or more walls 1570 of the cabinet 1562. The video device 1558 may further include additional decorative lights and speakers, which may be located on an underside surface 1566, for example, of a generally horizontally extending top 1568 of the cabinet 1562 of the video device 1558 generally extending toward the player positions 1514.

Although an embodiment is described showing individual discrete player stations, in some embodiments, the entire playing surface (e.g., player interface areas 1532, card screen 1564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client—server architecture (e.g., over the Internet, a local area network, etc.). FIG. 9 is a schematic block diagram of an illustrative gaming system 1600 for implementing wagering games according to this disclosure. The gaming system 1600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. § 2701 et seq. (“Indian Gaming Regulatory Act”). Such games may include banked and/or non-banked games.

The wagering games supported by the gaming system 1600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 1600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 1600 may include a gaming platform to establish a portal for an end user to access a wagering game hosted by one or more gaming servers 1610 over a network 1630. In some embodiments, games are accessed through a user interaction service 1612. The gaming system 1600 enables players to interact with a user device 1620 through a user input device 1624 and a display 1622 and to communicate with one or more gaming servers 1610 using a network 1630 (e.g., the Internet). Typically, the user device is remote from the gaming server 1610 and the network is the word-wide web (i.e., the Internet).

In some embodiments, the gaming servers 1610 may be configured as a single server to administer wagering games in combination with the user device 1620. In other embodiments, the gaming servers 1610 may be configured as separate servers for performing separate, dedicated functions associated with administering wagering games. Accordingly, the following description also discusses “services” with the understanding that the various services may be performed by different servers or combinations of servers in different embodiments. As shown in FIG. 9, the gaming servers 1610 may include a user interaction service 1612, a game service 1616, and an asset service 1614. In some embodiments, one or more of the gaming servers 1610 may communicate with an account server 1632 performing an account service 1632. As explained more fully below, for some wagering type games, the account service 1632 may be separate and operated by a different entity than the gaming servers 1610; however, in some embodiments the account service 1632 may also be operated by one or more of the gaming servers 1610.

The user device 1620 may communicate with the user interaction service 1612 through the network 1630. The user interaction service 1612 may communicate with the game service 1616 and provide game information to the user device 1620. In some embodiments, the game service 1616 may also include a game engine. The game engine may, for example, access, interpret, and apply game rules. In some embodiments, a single user device 1620 communicates with a game provided by the game service 1616, while other embodiments may include a plurality of user devices 1620 configured to communicate and provide end users with access to the same game provided by the game service 1616. In addition, a plurality of end users may be permitted to access a single user interaction service 1612, or a plurality of user interaction services 1612, to access the game service 1616. The user interaction service 1612 may enable a user to create and access a user account and interact with game service 1616. The user interaction service 1612 may enable users to initiate new games, join existing games, and interface with games being played by the user.

The user interaction service 1612 may also provide a client for execution on the user device 1620 for accessing the gaming servers 1610. The client provided by the gaming servers 1610 for execution on the user device 1620 may be any of a variety of implementations depending on the user device 1620 and method of communication with the gaming servers 1610. In one embodiment, the user device 1620 may connect to the gaming servers 1610 using a web browser, and the client may execute within a browser window or frame of the web browser. In another embodiment, the client may be a stand-alone executable on the user device 1620.

For example, the client may comprise a relatively small amount of script (e.g., JAVASCRIPT®), also referred to as a “script driver,” including scripting language that controls an interface of the client. The script driver may include simple function calls requesting information from the gaming servers 1610. In other words, the script driver stored in the client may merely include calls to functions that are externally defined by, and executed by, the gaming servers 1610. As a result, the client may be characterized as a “thin client.” The client may simply send requests to the gaming servers 1610 rather than performing logic itself. The client may receive player inputs, and the player inputs may be passed to the gaming servers 1610 for processing and executing the wagering game. In some embodiments, this may involve providing specific graphical display information for the display 1622 as well as game outcomes.

As another example, the client may comprise an executable file rather than a script. The client may do more local processing than does a script driver, such as calculating where to show what game symbols upon receiving a game outcome from the game service 1616 through user interaction service 1612. In some embodiments, portions of an asset service 1614 may be loaded onto the client and may be used by the client in processing and updating graphical displays. Some form of data protection, such as end-to-end encryption, may be used when data is transported over the network 1630. The network 1630 may be any network, such as, for example, the Internet or a local area network.

The gaming servers 1610 may include an asset service 1614, which may host various media assets (e.g., text, audio, video, and image files) to send to the user device 1620 for presenting the various wagering games to the end user. In other words, the assets presented to the end user may be stored separately from the user device 1620. For example, the user device 1620 requests the assets appropriate for the game played by the user; as another example, especially relating to thin clients, just those assets that are needed for a particular display event will be sent by the gaming servers 1610, including as few as one asset. The user device 1620 may call a function defined at the user interaction service 1612 or asset service 1614, which may determine which assets are to be delivered to the user device 1620 as well as how the assets are to be presented by the user device 1620 to the end user. Different assets may correspond to the various user devices 1620 and their clients that may have access to the game service 1616 and to different variations of wagering games.

The gaming servers 1610 may include the game service 1616, which may be programmed to administer wagering games and determine game play outcomes to provide to the user interaction service 1612 for transmission to the user device 1620. For example, the game service 1616 may include game rules for one or more wagering games, such that the game service 1616 controls some or all of the game flow for a selected wagering game as well as the determined game outcomes. The game service 1616 may include pay tables and other game logic. The game service 1616 may perform random number generation for determining random game elements of the wagering game. In one embodiment, the game service 1616 may be separated from the user interaction service 1612 by a firewall or other method of preventing unauthorized access to the game service 1612 by the general members of the network 1630.

The user device 1620 may present a gaming interface to the player and communicate the user interaction from the user input device 1624 to the gaming servers 1610. The user device 1620 may be any electronic system capable of displaying gaming information, receiving user input, and communicating the user input to the gaming servers 1610. For example, the user device 1620 may be a desktop computer, a laptop, a tablet computer, a set-top box, a mobile device (e.g., a smartphone), a kiosk, a terminal, or another computing device. As a specific, nonlimiting example, the user device 1620 operating the client may be an interactive electronic gaming system 1300. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 1610. The client may be illustrated within a casino webpage (or other interface) indicating that the client is embedded into a webpage, which is supported by a web browser executing on the user device 1620.

In some embodiments, components of the gaming system 1600 may be operated by different entities. For example, the user device 1620 may be operated by a third party, such as a casino or an individual, that links to the gaming servers 1610, which may be operated, for example, by a wagering game service provider. Therefore, in some embodiments, the user device 1620 and client may be operated by a different administrator than the operator of the game service 1616. In other words, the user device 1620 may be part of a third-party system that does not administer or otherwise control the gaming servers 1610 or game service 1616. In other embodiments, the user interaction service 1612 and asset service 1614 may be operated by a third-party system. For example, a gaming entity (e.g., a casino) may operate the user interaction service 1612, user device 1620, or combination thereof to provide its customers access to game content managed by a different entity that may control the game service 1616, amongst other functionality. In still other embodiments, all functions may be operated by the same administrator. For example, a gaming entity (e.g., a casino) may elect to perform each of these functions in-house, such as providing access to the user device 1620, delivering the actual game content, and administering the gaming system 1600.

The gaming servers 1610 may communicate with one or more external account servers 1632 (also referred to herein as an account service 1632), optionally through another firewall. For example, the gaming servers 1610 may not directly accept wagers or issue payouts. That is, the gaming servers 1610 may facilitate online casino gaming but may not be part of self-contained online casino itself. Another entity (e.g., a casino or any account holder or financial system of record) may operate and maintain its external account service 1632 to accept bets and make payout distributions. The gaming servers 1610 may communicate with the account service 1632 to verify the existence of funds for wagering and to instruct the account service 1632 to execute debits and credits. As another example, the gaming servers 1610 may directly accept bets and make payout distributions, such as in the case where an administrator of the gaming servers 1610 operates as a casino.

Additional features may be supported by the gaming servers 1610, such as hacking and cheating detection, data storage and archival, metrics generation, messages generation, output formatting for different end user devices, as well as other features and operations.

FIG. 10 is a schematic block diagram of a table 1682 for implementing wagering games including a live dealer video feed. Features of the gaming system 1600 (see FIG. 9) described above in connection with FIG. 9 may be utilized in connection with this embodiment, except as further described. Rather than cards being determined by computerized random processes, physical cards (e.g., from a standard, 52-card deck of playing cards) may be dealt by a live dealer 1680 at a table 1682 from a card-handling system 1684 located in a studio or on a casino floor. A table manager 1686 may assist the dealer 1680 in facilitating play of the game by transmitting a live video feed of the dealer's actions to the user device 1620 and transmitting remote player elections to the dealer 1680. As described above, the table manager 1686 may act as or communicate with a gaming system 1600 (see FIG. 9) (e.g., acting as the gaming system 1600 (see FIG. 9) itself or as an intermediate client interposed between and operationally connected to the user device 1620 and the gaming system 1600 (see FIG. 9)) to provide gaming at the table 1682 to users of the gaming system 1600 (see FIG. 9). Thus, the table manager 1686 may communicate with the user device 1620 through a network 1630 (see FIG. 9), and may be a part of a larger online casino, or may be operated as a separate system facilitating game play. In various embodiments, each table 1682 may be managed by an individual table manager 1686 constituting a gaming device, which may receive and process information relating to that table. For simplicity of description, these functions are described as being performed by the table manager 1686, though certain functions may be performed by an intermediary gaming system 1600 (see FIG. 9), such as the one shown and described in connection with FIG. 9. In some embodiments, the gaming system 1600 (see FIG. 9) may match remotely located players to tables 1682 and facilitate transfer of information between user devices 1620 and tables 1682, such as wagering amounts and player option elections, without managing gameplay at individual tables. In other embodiments, functions of the table manager 1686 may be incorporated into a gaming system 1600 (see FIG. 9).

The table 1682 includes a camera 1670 and optionally a microphone 1672 to capture video and audio feeds relating to the table 1682. The camera 1670 may be trained on the live dealer 1680, play area 1687, and card-handling system 1684. As the game is administered by the live dealer 1680, the video feed captured by the camera 1670 may be shown to the player remotely using the user device 1620, and any audio captured by the microphone 1672 may be played to the player remotely using the user device 1620. In some embodiments, the user device 1620 may also include a camera, microphone, or both, which may also capture feeds to be shared with the dealer 1680 and other players. In some embodiments, the camera 1670 may be trained to capture images of the card faces, chips, and chip stacks on the surface of the gaming table. Known image extraction techniques may be used to obtain card count and card rank and suit information from the card images.

Card and wager data in some embodiments may be used by the table manager 1686 to determine game outcome. The data extracted from the camera 1670 may be used to confirm the card data obtained from the card-handling system 1684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card-handling system 1684 and play the game as though the player were at a gaming table, playing with other players in a live casino. In addition, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players.

The card-handling system 1684 may be as shown and was described previously. The play area 1686 depicts player layouts for playing the game. As determined by the rules of the game, the player at the user device 1620 may be presented options for responding to an event in the game using a client as described with reference to FIG. 9.

Player elections may be transmitted to the table manager 1686, which may display player elections to the dealer 1680 using a dealer display 1688 and player action indicator 1690 on the table 1682. For example, the dealer display 1688 may display information regarding where to deal the next card or which player position is responsible for the next action.

In some embodiments, the table manager 1686 may receive card information from the card-handling system 1684 to identify cards dealt by the card-handling system 1684. For example, the card-handling system 1684 may include a card reader to determine card information from the cards. The card information may include the rank and suit of each dealt card and hand information.

The table manager 1686 may apply game rules to the card information, along with the accepted player decisions, to determine gameplay events and wager results. Alternatively, the wager results may be determined by the dealer 1680 and input to the table manager 1686, which may be used to confirm automatically determined results by the gaming system.

Card and wager data in some embodiments may be used by the table manager 1686 to determine game outcome. The data extracted from the camera 1670 may be used to confirm the card data obtained from the card-handling system 1684, to determine a player position that received a card, and for general security monitoring purposes, such as detecting player or dealer card switching, for example.

The live video feed permits the dealer to show cards dealt by the card-handling system 1684 and play the game as though the player were at a live casino. In addition, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players.

FIG. 11 is a simplified block diagram showing elements of computing devices that may be used in systems and apparatuses of this disclosure. A computing system 1640 may be a user-type computer, a file server, a computer server, a notebook computer, a tablet, a handheld device, a mobile device, or other similar computer system for executing software. The computing system 1640 may be configured to execute software programs containing computing instructions and may include one or more processors 1642, memory 1646, one or more displays 1658, one or more user interface elements 1644, one or more communication elements 1656, and one or more storage devices 1648 (also referred to herein simply as storage 1648).

The processors 1642 may be configured to execute a wide variety of operating systems and applications including the computing instructions for administering wagering games of the present disclosure.

The processors 1642 may be configured as a general-purpose processor such as a microprocessor, but in the alternative, the general-purpose processor may be any processor, controller, microcontroller, or state machine suitable for carrying out processes of the present disclosure. The processor 1642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 1646 may be used to hold computing instructions, data, and other information for performing a wide variety of tasks including administering wagering games of the present disclosure. By way of example, and not limitation, the memory 1646 may include Synchronous Random Access Memory (SRAM), Dynamic RAM (DRAM), Read-Only Memory (ROM), Flash memory, and the like.

The display 1658 may be a wide variety of displays such as, for example, light-emitting diode displays, liquid crystal displays, cathode ray tubes, and the like. In addition, the display 1658 may be configured with a touch-screen feature for accepting user input as a user interface element 1644.

As nonlimiting examples, the user interface elements 1644 may include elements such as displays, keyboards, push-buttons, mice, joysticks, haptic devices, microphones, speakers, cameras, and touchscreens.

As nonlimiting examples, the communication elements 1656 may be configured for communicating with other devices or communication networks. As nonlimiting examples, the communication elements 1656 may include elements for communicating on wired and wireless communication media, such as for example, serial ports, parallel ports, Ethernet connections, universal serial bus (US B) connections, IEEE 1394 (“firewire”) connections, THUNDERBOLT™ connections, BLUETOOTH® wireless networks, ZigBee wireless networks, 802.11 type wireless networks, cellular telephone/data networks, fiber optic networks and other suitable communication interfaces and protocols.

The storage 1648 may be used for storing relatively large amounts of nonvolatile information for use in the computing system 1640 and may be configured as one or more storage devices. By way of example and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 1640 may be configured in many different ways with different types of interconnecting buses between the various elements. Moreover, the various elements may be subdivided physically, functionally, or a combination thereof. As one nonlimiting example, the memory 1646 may be divided into cache memory, graphics memory, and main memory. Each of these memories may communicate directly or indirectly with the one or more processors 1642 on separate buses, partially combined buses, or a common bus.

As a specific, nonlimiting example, various methods and features of the present disclosure may be implemented in a mobile, remote, or mobile and remote environment over one or more of Internet, cellular communication (e.g., Broadband), near field communication networks and other communication networks referred to collectively herein as an iGaming environment. The iGaming environment may be accessed through social media environments such as FACEBOOK® and the like. DragonPlay Ltd, acquired by Bally Technologies Inc., provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted the features can be expressed as entertainment only gaming where players wager virtual credits having no value or risk no wager whatsoever such as playing a promotion game or feature.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” or “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

The embodiments also relate to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method comprising:
determining, by one or more processors associated with a smart card-handling device in response to dealer input received after an initial deal for a playing round of a blackjack game, that an upward-facing card of a dealer's initial hand indicates a first required rank value of a natural hand;
automatically detecting, by the one or more processors based on an electronic analysis of card-draw timestamp data, an electronic analysis of card-draw image data, and an electronic analysis of game settings, whether a rank value of a downward-facing card of the dealer's initial hand indicates a second required rank value of the natural hand, wherein the automatically detecting occurs without exposing the downward-facing card and prior to another card being drawn, for the playing round, after the initial deal; and
in response to the automatically detecting whether the rank value of the downward-facing card indicates the second required rank value, indicating, by the processor via one or more electronic indicators, whether the dealer's initial hand either equates to the natural hand or does not equate to the natural hand.

2. The method of claim 1, wherein the electronic analysis of the card-draw timestamp data comprises:
recording, in response to cards being drawn from the smart card-handling device, the card-draw timestamp data;
detecting, via the analysis of the card-draw timestamp data, a burst of timestamps having a card-draw timing pattern that matches a burst-timing pattern indicative of the initial deal, wherein the burst-timing pattern comprises a plurality of card-draw timestamps within a second of one another, wherein the plurality of card-draw timestamps occur between a first long pause prior to the initial deal and a second long pause that occurs after the dealer input is received.

3. The method of claim 2, wherein the dealer input comprises a press of a button associated with the smart card-handling device.

4. The method of claim 2, wherein the dealer input comprises one or more of a return of previously dealt cards to a card-return receptacle of the smart card-handling device, insertion of the dealer's initial hand into a card reader, or a dealing action detectable via a machine-learning model, wherein the dealing action occurs at a dealer station of a gaming table at which the blackjack game is conducted, and wherein the upward-facing card and the downward-facing card are dealt to the dealer station.

5. The method of claim 2, wherein the electronic analysis of the game settings comprises:
detecting, via analysis of game rules stored in the game settings, a known number of cards required to be dealt to each participant of the blackjack game during the initial deal, a known dealing pattern for the blackjack game, and a required rank-value pairing for the natural hand.

6. The method of claim 5, wherein the automatically detecting comprises:
determining, based on a total number of timestamps in the burst of timestamps, a total number of cards dealt for the initial deal;
determining, in response to analysis of the burst of time stamps, a drawing order for the initial deal;
determining, by dividing the total number of cards dealt by the known number of cards required to be dealt to each participant, a first card-draw position in the drawing order for a first member of a group consisting of the upward-facing card and the downward-facing card;
determining, in response to the dealer input, a second card-draw position in the drawing order for a second member of the group consisting of the upward-facing card and the downward-facing card;
detecting, by the processor via card-recognition analysis of a portion of the card-draw image data that is related to the first card-draw position and the second card-draw position, a first rank value for the first member and a second rank value for the second member; and
determining, based on comparison of a combination of the first rank value and the second rank value to the required rank-value pairing for the natural hand, whether the first rank value indicates the first required rank value and whether the second rank value indicates the second required rank value.

7. The method of claim 6, wherein the indicating comprises:
determining, in response to the automatically detecting, that the first rank value indicates the first required rank value and that the second rank value indicates the second required rank value; and
presenting, via at least one of the one or more electronic indicators, an indication that the dealer's initial hand equates to the natural hand and that the playing round is over.

8. The method of claim 6, wherein the indicating comprises:
determining, in response to the automatically detecting, that either the first rank value does not indicate the first required rank value or that the second rank value does not indicate the second required rank value; and
presenting, via at least one of the one or more electronic indicators, an indication that the dealer's initial hand does not equate to the natural hand and that the playing round is not over.

9. The method of claim 1, wherein the one or more electronic indicators include a first electronic indicator that has a first configurable color setting and a second electronic indicator that a second configurable color setting, wherein the first configurable color setting specifies a first color, and wherein the second configurable color setting specifies a second color different from the first color.

10. A system comprising:
one or more electronic indicators; and
one or more processors, wherein the one or more processors are configured to execute instructions, which when executed cause the system to perform operations to:
determine, in response to dealer input received after an initial deal for a playing round of a blackjack game, that an upward-facing card of a dealer's initial hand indicates a first required rank value of a natural hand;
automatically detect, based on an electronic analysis of card-draw timestamp data, an electronic analysis of card-draw image data, and an electronic analysis of game settings, whether a rank value of a downward-facing card of the dealer's initial hand indicates a second required rank value of the natural hand, wherein the automatically detecting occurs without exposing the downward-facing card and prior to another card being drawn, for the playing round, after the initial deal; and
in response to automatically detection of whether the rank value of the downward-facing card indicates the second required rank value, indicate, via the one or more electronic indicators, whether the dealer's initial hand either equates to the natural hand or does not equate to the natural hand.

11. The system of claim 10, wherein the one or more processors are further configured to execute instructions for the electronic analysis of the card-draw timestamp data, wherein the instructions for the electronic analysis of the card-draw timestamp data cause the system to perform operations to:
record, in response to cards being drawn from a smart card-handling device, the card-draw timestamp data;
detect, via the analysis of the card-draw timestamp data, a burst of timestamps having a card-draw timing pattern that matches a burst-timing pattern indicative of the initial deal, wherein the burst-timing pattern comprises a plurality of card-draw timestamps within a second of one another, wherein the plurality of card-draw timestamps occur between a first long pause prior to the initial deal and a second long pause that occurs after the dealer input is received.

12. The system of claim 11, wherein the dealer input comprises a press of a button associated with the smart card-handling device.

13. The system of claim 11, wherein the dealer input comprises one or more of a return of previously dealt cards to a card-return receptacle of the smart card-handling device, insertion of the dealer's initial hand into a card reader, or a dealing action detectable via a machine-learning model, wherein the dealing action occurs at a dealer station of a gaming table at which the blackjack game is conducted, and wherein the upward-facing card and the downward-facing card are dealt to the dealer station.

14. The system of claim 11, wherein the one or more processors are further configured to execute instructions for the electronic analysis of the game settings, wherein the instructions for the electronic analysis of the game settings cause the system to perform operations to:
detect, via analysis of game rules stored in the game settings, a known number of cards required to be dealt to each participant of the blackjack game during the initial deal, a known dealing pattern for the blackjack game, and a required rank-value pairing for the natural hand.

15. The system of claim 14, wherein the one or more processors are further configured to execute instructions, which when executed, cause the system to perform operations to:
determine, based on a total number of timestamps in the burst of timestamps, a total number of cards dealt for the initial deal;
determine, in response to analysis of the burst of timestamps, a drawing order for the initial deal;
determine, by dividing the total number of cards dealt by the known number of cards required to be dealt to each participant, a first card-draw position in the drawing order for a first member of a group consisting of the upward-facing card and the downward-facing card;
determine, in response to the dealer input, a second card-draw position in the drawing order for a second member of the group consisting of the upward-facing card and the downward-facing card;
detect, via card-recognition analysis of a portion of the card-draw image data that is related to the first card-draw position and the second card-draw position, a first rank value for the first member and a second rank value for the second member; and
determine, based on comparison of a combination of the first rank value and the second rank value to the required rank-value pairing for the natural hand, whether the first rank value indicates the first required rank value and whether the second rank value indicates the second required rank value.

16. The system of claim 15, wherein the one or more processors are further configured to execute instructions, which when executed, cause the system to perform operations to:
determine that the first rank value indicates the first required rank value and that the second rank value indicates the second required rank value; and
present, via at least one of the one or more electronic indicators, an indication that the dealer's initial hand equates to the natural hand and that the playing round is over.

17. The system of claim 15, wherein the one or more processors are further configured to execute instructions, which when executed, cause the system to perform operations to:
determine that either the first rank value does not indicate the first required rank value or that the second rank value does not indicate the second required rank value; and
present, via at least one of the one or more electronic indicators, an indication that the dealer's initial hand does not equate to the natural hand and that the playing round is not over.

18. The system of claim 10, wherein the one or more electronic indicators include a first electronic indicator that has a first configurable color setting and a second electronic indicator that a second configurable color setting, wherein the first configurable color setting specifies a first color, and wherein the second configurable color setting specifies a second color different from the first color.

19. The system of claim 10, wherein the one or more processors comprise one or more of a processor from a smart card-handling device or a processor of a gaming device connected to one or more gaming networks.
